(19) United States
(12) Patent Application Publication
(10) Pub. No.: US 2018/0374376 A1
(43) Pub. Date: Dec. 27, 2018

(54) METHODS AND SYSTEMS OF FACILITATING TRAINING BASED ON MEDIA

(71) Applicant: CDG Innovations LLC, Miami, FL (US)

(72) Inventors: David Larry Kay, Sunny Isle Beach, FL (US); Juan Carlos Vazquez, Miami, FL (US)

(21) Appl. No.: 16/016,036

(22) Filed: Jun. 22, 2018

Related U.S. Application Data
(60) Provisional application No. 62/524,136, filed on Jun. 23, 2017.

(51) Int. Cl. G09B 5/14; G09B 5/06; G09B 19/04; G09B 7/04

(52) U.S. Cl. CPC G09B 5/14; G09B 5/065; G06K 9/00302; G09B 7/04; G09B 19/04

(57) ABSTRACT

Disclosed is a method of facilitating training based on media. The method may include receiving, using a communication device, a trainer media from a trainer device. Further, the method may include storing, using a storage device, the trainer media.

Further, the method may include transmitting, using the communication device, the trainer media to a trainee device. Further, the method may include receiving, using the communication device, a trainee media from the trainee device. Further, the method may include storing, using the storage device, the trainee media. Further, the method may include analyzing, using a processing device, the trainee media. Further, the method may include generating, using the processing device, at least one trainee characteristic based on the analyzing of the trainee media. Further, the method may include transmitting, using the communication device, the at least one trainee characteristic to the trainee device.

### FIELD OF THE INVENTION

The present invention relates generally relates to the field of data processing. More specifically, the present disclosure relates to methods and systems of facilitating training of users.

### BACKGROUND OF THE INVENTION

Current e-learning systems do not match the performance challenges of face-to-face communication. Further, they do not provide rehearsal or performance support at the moment of need. Accordingly, they achieve low-to-moderate success rates of new skill acquisition and retention. Additionally, they do not address verbal and non-verbal communications skills training.

Further, the current e-learning systems may variably employ training techniques and strategies including gamification, scenarios, storytelling. For example, Q&A, Drag and Drop, and Point and Click interfaces do not engage the learner with sufficient emotional intensity necessary to effectively select and lay down a memory. Eliciting a trainee's attention and emotional arousal are critical to behavior modification and new skill acquisition. Current e-learning systems deliver poor to mediocre results on this level.

Therefore, there is a need for improved methods and systems to facilitate training based on media that may overcome one or more of the abovementioned problems and/or limitations.

### SUMMARY

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to an aspect, a method of facilitating training based on media is disclosed. The method may include receiving, using a communication device, a trainer media from a trainer device. Further, the method may include storing, using a storage device, the trainer media. Further, the method may include transmitting, using the communication device, the trainer media to a trainee device. Further, the method may include receiving, using the communication device, a trainee media from the trainee device. Further, the method may include storing, using the storage device, the trainee media. Further, the method may include analyzing, using a processing device, the trainee media. Further, the method may include generating, using the processing device, at least one trainee characteristic based on the analyzing of the trainee media. Further, the method may include transmitting, using the communication device, the at least one trawlee characteristic to the trainee device.

According to another aspect, a system for facilitating training based on media is also disclosed. The system may include a communication device configured for receiving a trainer media from a trainer device. Further, the communication device may be configured for transmitting the trainer media to a trainee device. Further, the communication device may be configured for receiving a trainee media from the trainee device. Further, the communication device may be configured for transmitting at least one trainee characteristic to the trainee device. Further, the system may include a processing device configured for analyzing the trainee media. Further, the processing device may be configured for generating the at least one trainee characteristic based on the analyzing of the trainee media. Further, the system may include a storage device configured for storing each of the trainer media and the trainee media.

According to an aspect, a virtual (cloud-based) training platform is disclosed. The platform may be engineered by educators to expedite social, academic, and workplace learning by increasing retention, thereby transforming performance along with the ability for a physical workstation to exist for training that incorporates multiple participants.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is a block diagram of a system for facilitating training based on media, in accordance with some embodiments.

FIG. 3 is a flowchart of a method of facilitating training based on media, in accordance with some embodiments.

FIG. 4 is a flowchart of a method of obtaining a trainer script, in accordance with some embodiments.

FIG. 5 is a flowchart of a method of obtaining a manual feedback from a coach or a trainer, in accordance with some embodiments.

FIG. 6 is a flowchart of a method of providing at least one trainer characteristic to a trainee device, in accordance with some embodiments.

FIG. 7 is a flowchart of a method of obtaining a trainee script, in accordance with some embodiments.

FIG. 8 is a flowchart of a method of determining at least one emotional indicator in the at least one trainee characteristic, in accordance with some embodiments.

FIG. 9 is a flowchart of a method of obtaining a motion sensor data from the trainee device, in accordance with some embodiments.

FIG. 10 illustrates a user interface of a vR application that allows the trainee to navigate to a lesson, in accordance with an exemplary embodiment.

FIG. 11 illustrates a user interface of the vR application that allows the trainee to review his/her rehearsal timeline, in accordance with an exemplary embodiment.

FIG. 12 illustrates a user interface of a home page of the vR application that allows the trainee to review his/her rehearsal timeline, in accordance with an exemplary embodiment.

FIG. 13 illustrates a user interface related to a courses page of the vR application, in accordance with an exemplary embodiment.

FIG. 14 illustrates a user interface related to a feedback page of the vR application, in accordance with an exemplary embodiment.

FIG. 15 illustrates a user interface related to a task page of the vR application, in accordance with an exemplary embodiment.

FIG. 16 illustrates a user interface related to a chat page of the vR application, in accordance with an exemplary embodiment.

FIG. 17 illustrates a user interface related to a groups page of the vR application, in accordance with an exemplary embodiment.

FIG. 18 illustrates a user interface related to a “my tools” page of the vR application, in accordance with an exemplary embodiment.

FIG. 19 illustrates a user interface related to a rehearsals page of the vR application, in accordance with an exemplary embodiment.

FIG. 20 illustrates a user interface related to an instructor interface of the vR application, in accordance with an exemplary embodiment.

FIG. 21 illustrates a user interface related to a “Coaching Tools” tab on the instructor interface of the vR application, in accordance with an exemplary embodiment.

FIG. 22 illustrates a user interface related to a “Creator Space” tab on the instructor interface of the vR application, in accordance with an exemplary embodiment.

FIG. 23 illustrates a user interface related to a “create course” page of the vR application, in accordance with an exemplary embodiment.

FIG. 24 illustrates user interfaces related to privacy and language options for a course, in accordance with an exemplary embodiment.

FIG. 25 illustrates a user interface related to the “Creator Space” tab of the vR application, in accordance with an exemplary embodiment.

FIG. 26 illustrates a user interface related to a “Create Topic” page of the vR application, in accordance with an exemplary embodiment.

FIG. 27 illustrates a user interface related to a Topics page of the vR application, in accordance with an exemplary embodiment.

FIG. 28 illustrates a user interface related to an EPM page of the vR application, in accordance with an exemplary embodiment.

FIG. 29 illustrates a user interface related to an Explanation page of the vR application, in accordance with an exemplary embodiment.

FIG. 30 illustrates a user interface related to a primary explanation page of the vR application, in accordance with an exemplary embodiment.

FIG. 31 illustrates a user interface related to a prompt page of the vR application, in accordance with an exemplary embodiment.

FIG. 32 illustrates a user interface related to a model page of the vR application, in accordance with an exemplary embodiment.

FIG. 33 illustrates a user interface showing an explanation, prompt, and model, in accordance with an exemplary embodiment.

FIG. 34 illustrates a user interface related to a home page (of the trainee) of the vR application, in accordance with an exemplary embodiment.

FIG. 35 illustrates a user interface of a settings page of the vR application, in accordance with an exemplary embodiment.

FIG. 36 illustrates a user interface of a course page of the vR application, in accordance with an exemplary embodiment.

FIG. 37 illustrates a user interface related to a feedback page of the vR application, in accordance with an exemplary embodiment.

FIG. 38 illustrates a user interface related to a task page of the vR application, in accordance with an exemplary embodiment.

FIG. 39 illustrates a user interface related to a chat page of the vR application, in accordance with an exemplary embodiment.

FIG. 40 illustrates a user interface related to a groups page of the vR application, in accordance with an exemplary embodiment.

FIG. 41 illustrates a user interface related to the home page of the vR application, in accordance with an exemplary embodiment.

FIG. 42 illustrates a user interface allowing choosing a topic, in accordance with an exemplary embodiment.

FIG. 43 illustrates a user interface allowing choosing a lesson, in accordance with an exemplary embodiment.

FIG. 44 illustrates a user interface related to an explanation page of the vR application, in accordance with an exemplary embodiment.

FIG. 45 illustrates a user interface related to a demonstration page of the vR application, in accordance with an exemplary embodiment.

FIG. 46 illustrates a user interface related to a practice page of the vR application, in accordance with an exemplary embodiment.

FIG. 47 illustrates a vR workstation, in accordance with an exemplary embodiment.

FIG. 48 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context training users, in accordance with some embodiments, embodiments of the present disclosure are not limited to use only in this context.

### Overview

The present disclosure relates to a video system. Further, the present disclosure relates to a method and system for a virtual (cloud-based) training platform engineered by educators to expedite social, academic, and workplace learning by increasing retention, thereby transforming performance. The system may also incorporate a physical workstation which allows for the trainee to self-reflect in a comfortable, ergonomic arrangement combined with the ability to add additional participants—trainees, trainers, etc.

Further, the present disclosure relates to a method and system for a virtual (cloud-based) training platform engineered by educators to expedite social, academic, and workplace learning by increasing retention, thereby transforming performance. According to some aspects, a virtual (cloud-based) training platform “Video Rehearser” is disclosed. The platform is engineered using social, educational & neurobehavioral principles to help learners meet performance standards and help trainers/teachers/educators deliver engaging and effective content. The platform is user content driven and content can be created in real-time or pre-recorded and uploaded later.

The Video Rehearser may address the global eLearning market by providing a platform that allows for role development, modeling, training and coaching. It allows for delivering a variety of virtual and real-time on the job experiences that maximize return on training time and training dollars. The platform focuses on performance, not just delivering content.

The platform allows for easy uploading of user generated content and virtual behavioral management for trainers and teachers looking to provide instant feedback virtually through modeling, training, and coaching. The platform incorporates features similar to a Learning Management System (LMS) but applies neurobehavioral and educational principles to elevate it to a Training Management System (TMS). A TMS measures the amount learned as demonstrated by on the job performance as opposed to an LMS which measures what courses have been taken or how many ‘badges’ one has earned—a framework called pretendication.

Further, the Video Rehearser is an on-line system for enhancing retention, comprehension and application of on the job communication skills. The Video Rehearser uses instant replay (video) to help people express themselves more clearly and persuasively. The Video Rehearser is a rapid development and deployment tool for training and performance support. The Video Rehearser provides an intuitive interface that's simple to learn and easy to operate. The Video Rehearser may be designed for jobs/employees that require specific communication skills and language such as: customer service, compliance, sales, pitches/presentations and accent reduction (many more). The Video Rehearser may be based on the latest techniques in brain and behavioral science. The Video Rehearser may repurpose pre-existing training assets i.e. videos, print or classroom materials. The Video Rehearser may operate according to a What You See Is What You DO (WYSIWYD) training method. The Video Rehearser may engage and maintain maximum attention for maximum learning and retention. The Video Rehearser may rehearse employees through job scenarios as they happen. The Video Rehearser may develop decision making skills. The Video Rehearser may be used to train both new and experienced employees at all levels of your organization from entry level to senior management.

According to some embodiments, the Video Rehearser may allow a trainer to effectively train trainees. The trainer may identify performance objectives. Further, the trainer may create lessons based on the following hierarchy: courses, topics, lessons and concepts. A course is a collection of topics (such as Hospitality). A topic is a collection of lessons (such as Front Desk Greetings). A lesson is a collection of concepts (such as greeting hotel customer). A concept is a smallest unit (such as clarity of speech). The trainer may record various videos for each of the courses, topics, lessons and concepts.

Further, the concepts may be related to E (Explanation), P (Prompt) and M (Model). The E (Explanation) may be recorded to accompany various parts of the training process—typically, it may be recorded to describe what the trainee will do during the lesson. The P (Prompt) may be what starts the lesson—it can be a question, picture, statement, sound, etc. It is the stimulus that elicits a response. The M (Model) may be a role model. It may be the best practice response to a prompt in a lesson. The trainee May then emulate the role model and uses his/her own script. The trainee may rehearse using the rehearsal window and submit the rehearsal that he/she feels most comfortable with. Further, the trainee may review his/her submission. Further, facial recognition and emotion analysis may be used to show the trainee what emotion he/she is expressing. This helps in the self-reflective process. This learning path may allow for transitioning from practicing chunk by chunk into mastering a complete chain. Generally, authentic (Real life) interactions are too long (time, words, complexity) for most students to absorb in a few tries.

The disclosed trainee process includes a trainee joining a course. The trainee may get an email invite to join a course. The trainee may browse courses and sign up for a free course. The trainee may browse paid courses. Further, the trainee process may allow the trainee to navigates to a lesson. The lesson types may include Explanation−Prompt−Rehearsal+REHEARSAL WINDOW; Explanation−Model+REHEARSAL WINDOW; Explanation−Prompt+REHEARSAL WINDOW and Prompt+REHEARSAL WINDOW. Thereafter, the trainee may record him/herself. The trainee may record until he/she feels comfortable with the rehearsal enough to submit it for feedback/approval (iterative process). The trainee may review his/her rehearsal timeline that also includes emotional analysis to let the trainee know what emotions he/she showed throughout the rehearsal submission. The trainee may be notified what the manager (person responsible) marks the rehearsal submission. The marks may include an approved mark (rehearsal submission is accepted), a feedback mark (the trainee receives video feedback on how to improve) and a rating mark (Trainee's submission is rated 1-5 stars). Further, the trainee may receive feedback. The feedback may be in the form of self-reflection, such that each time the student reviews his/her performance, the trainee is giving self-feedback. The feedback may be received from a coach (user type) who may also be a peer/classmate. The feedback may be received from an instructor (user type). The feedback may be received from market of coaches who may be paid to give feedback.

Further, the Video Rehearser may include an Audio to Text (Script box). Therefore, as a person records any E, M, P or R (Explanation, Model, Prompt or Rehearsal) their audio is converted to text and appears in the appropriate text box. This may be done live as it's recorded or during the playback of a clip. The trainee may also have an option of typing out their ‘script’ into the script box before recording.

The Video Rehearser may provide graphic overlays and teleprompter functionality.

Further, a Role-Playing-Game (RPG) feature may allow a trainee to follow a story to answer prompts and move on to a next lesson.

Further, a Media Bin feature may allow for quick recording of media that may be used as one of the course components (Course intro video, Explanation, Prompt, Role Model). Further, different media types may be added to the screen such as images, presentations, documents, etc.

Further, a disclosed coach process may allow people to sign up to give feedback based on their feedback and a percentage on the interaction may be charged. The trainee may search through coaches to determine who to ask for help. The process of getting short video snippet feedback may calculate charge based on time.

In an exemplary embodiment, a pronunciation Lesson may be provided using disclosed video rehearser. The lesson may use facial recognition to alert the trainee as to whether or not their face matched with the standard format of that which is pronounced. For example, the pronunciation of the letter B has a specific way to form the mouth, lips, and teeth. When a trainee rehearses, they may see whether or not they have met the role model goal. The mouth of the trainee has to match the form shown by the model and the mouth is scanned to ensure that the correct shape is made by the trainee.

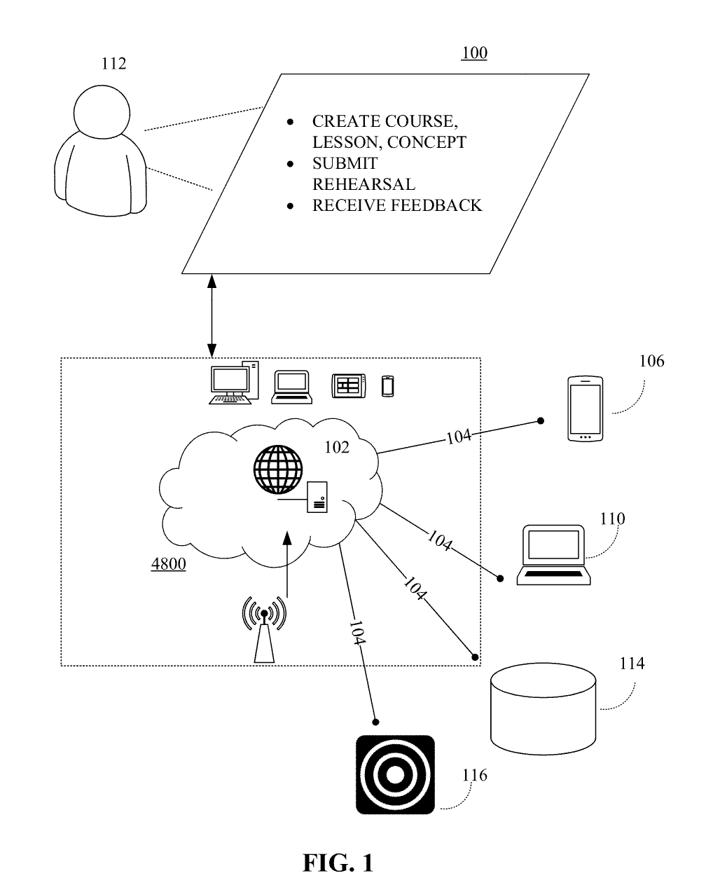

Referring now to figures, FIG. 1 is an illustration of a platform consistent with various embodiments of the present disclosure. By way of non-limiting example, the online platform 100 for facilitating training based on media may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), and databases 114 (such as databases storing trainer media) and sensors 116 (such as motion sensors), over a communication network 104, such as, but not limited to, the Internet. Further, users of the platform 100 may include relevant parties such as one or more of users, trainers, trainees, administrators, etc. Accordingly, electronic devices operated by the one or more relevant parties may be in communication with the online platform 100.

A user 112, such as the one or more relevant parties, may access online platform 100 through a web-based software application or browser. The web-based software application may be embodied as, for example, but not be limited to, a website, a web application, a desktop application, and a mobile application compatible with a computing device 4800.

According to some embodiments, the online platform 100 may communicate with a system 200 for facilitating training based on media. For instance, the media may include one or more of audio content, video content and multimedia content. The media may convey sensory and/or perceptual stimuli to each of the four senses including visual, audio, touch and proprioception.

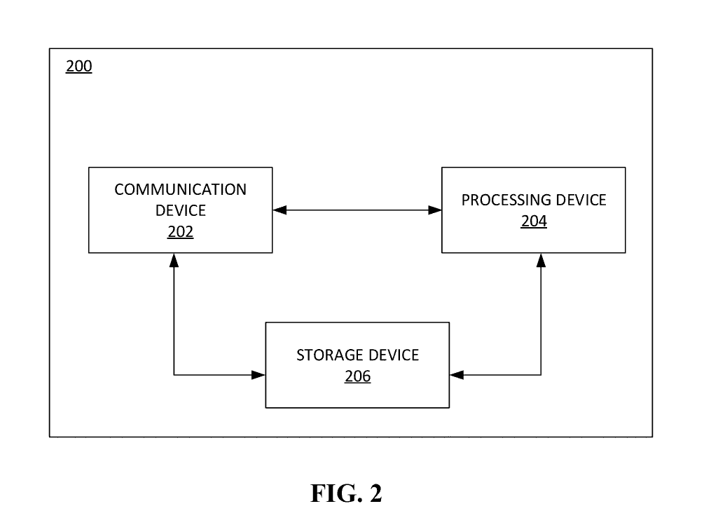

FIG. 2 is a block diagram of the system 200 for facilitating training based on media in accordance with some embodiments. The system 200 may include a communication device 202 configured for receiving a trainer media from a trainer device (such as the mobile device 106 and the electronic devices 110). In some embodiments, the trainer device may be media capturing device installed in the vicinity of the trainer. For example, the trainer device may be a CCTV camera installed in a facility. Further, the trainer media may be associated with at least one of a course, a topic and a lesson. Further, the trainer media may include at least one of a video recording, an audio recording, an audio-video recording and so on. In some embodiments, the trainer media may also via shared screens with a trainer wherein the trainer may use one or more of a remote mouse, keyboard, verbal commands and/or text messages. Further, the trainer may perform role modeling themselves.

Further, the communication device 202 may be configured for transmitting the trainer media to a trainee device (such as the mobile device 106 and the electronic devices 110). In some embodiments, the trainee device may be media capturing device installed in the vicinity of the trainee. For example, the trainee device may be a CCTV camera installed in a facility.

In further embodiments, the trainer media may include a prompt portion. The prompt portion may be related to a situation to which the trainee needs to respond. For example, the prompt portion may be related to a situation where a customer says hello to the trainee. Further, capturing of the trainee media may be automatically initiated upon presentation of the prompt portion. In further embodiments, the trainer media further may include a model portion. The model portion may indicate the type of response expected for a corresponding prompt portion. In some embodiments, one or more of the prompt portion and the model portion may be associated with an interactive cue-point. Further, the interactive cue-point may be configured to present one or more of the prompt portion and the model portion based on a user interaction with the interactive cue-point. For example, a long trainer media may include multiple interactive cue-points corresponding to multiple prompt portions. Accordingly, a trainee may use one or more interactive cue-points in the multiple interactive cue-points to train for the respective prompt portions.

Further, the communication device 202 may be configured for receiving a trainee media from the trainee device. Further, the communication device 202 may be configured for transmitting at least one trainee characteristic to the trainee device.

Further, the system 200 may include a processing device 204 configured for analyzing the trainee media. In some embodiments, the analyzing may include facial expression analysis, gesture analysis, body language analysis and so on. Further, in some embodiments, the analyzing may include voice analysis, speech analysis, language analysis and so on. Further, the analyzing may provide an objective representation of the trainee media which induces self-processes and self-referential phenomena arising from neural pathway which result in thoughts, emotions and behavior.

Further, the processing device 204 may be configured for generating the at least one trainee characteristic based on the analyzing of the trainee media. In some embodiments, the at least one trainee characteristic may include an emotional indicator, such as a type and intensity of one or more emotions expressed by the trainee in the trainee media. Further, the at least one trainee characteristic may relate to neural pathways including, but not limited to, self-referential encoding, reward and reinforcement, implicit and explicit decision making and self-regulation.

In further embodiments, the analyzing may include identifying a face of the trainee and recognizing the at least one emotional indicator associated with the face.

Further, the system 200 may include a storage device 206 configured for storing each of the trainer media and the trainee media.

In some embodiments, the communication device 202 may be further configured for receiving a trainer script from the trainer device. Further, the processing device 204 may be further configured for associating the trainer script with the trainer media. Further, the storage device 206 may be configured for storing the trainer script. The trainer script may be transmitted to the trainee device along with the trainer media. Moreover, the trainer script may be presented to the trainee along with the trainer media.

In some embodiments, the communication device 202 may be further configured for transmitting the trainee media to at least one coach device and receiving coach feedback from the at least one coach device. This may allow the trainee to receive a manual feedback from a coach or a trainer. Further, the storage device 206 may be further configured for storing the coach feedback in association with the trainee media.

In some embodiments, the processing device 204 may be further configured for analyzing the trainer media. In some embodiments, the analyzing may include facial expression analysis, gesture analysis, body language analysis and so on. Further, in some embodiments, the analyzing may include voice analysis, speech analysis, language analysis and so on. Further, the processing device 204 may be configured for generating at least one trainer characteristic based on the analyzing. In some embodiments, the at least one trainer characteristic may include an emotional indicator (e.g. a type and intensity of one or more emotions expressed by the trainer in the trainer media). Further, the communication device 202 may be configured for transmitting the at least one trainer characteristic to the trainee device. Accordingly, the emotional indicators of the trainer may be presented to the trainee in order to facilitate a comparison and subsequent correction. For example, the emotional indicators of the trainer may be presented to the trainee by super-imposing the trainer emotion indicators over the trainee emotion indicators. Accordingly, the analyzing the trainer media may provide another guide for the trainees.

In some embodiments, the processing device 204 may be further configured for generating trainee text corresponding to trainee speech comprised in the trainee media based on the analyzing of the trainee media. For example, the trainee text may be generated using a speech to text software. Further, the storage device 206 may be further configured for storing the trainee text in association with the trainee media. Further, the communication device 202 may be further configured for transmitting the trainee text to the trainee device.

In some embodiments, the communication device 202 may be further configured for receiving motion sensor data from the trainee device. For example, the motion sensor data may provide information about movements (such as hand movements, walking etc.) performed by the trainee. Further, the processing device 204 may be further configured for analyzing the motion sensor data. Further, generating the at least one trainee characteristic may be further based on the analyzing of the motion sensor data.

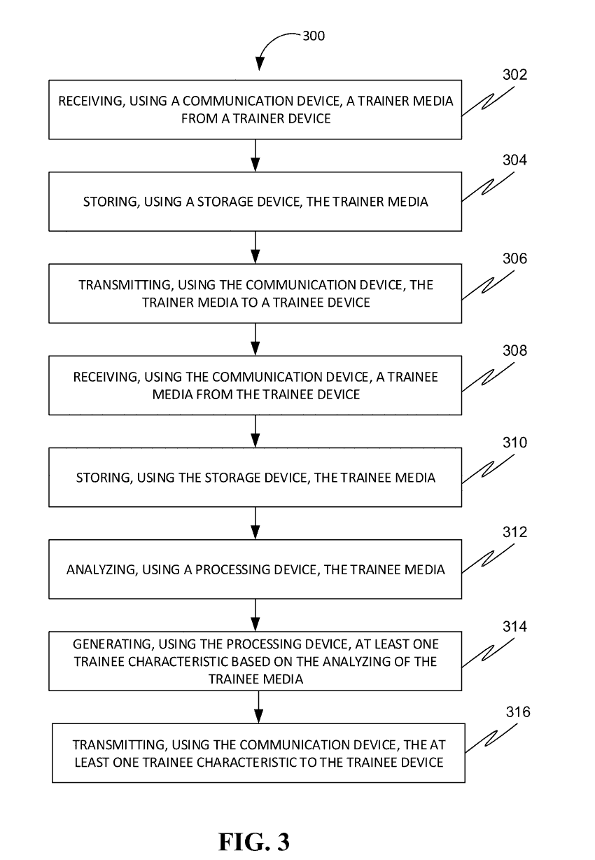

FIG. 3 is a flowchart of a method 300 of facilitating training based on media, in accordance with some embodiments. At 302, the method 300 may include receiving, using a communication device (such as the communication device 202), a trainer media from a trainer device. At 304, the method 300 may include storing, using a storage device (such as the storage device 206), the trainer media. In some embodiments, the trainer device may be media capturing device installed in the vicinity of the trainer. For example, the trainer device may be a CCTV camera installed in a facility. Further, the trainer media may be associated with at least one of a course, a topic and a lesson. Further, the trainer media may include at least one of a video recording, an audio recording, an audio-video recording and so on. In some embodiments, the trainer media may also via shared screens with a trainer wherein the trainer may use one or more of a remote mouse, keyboard, verbal commands and/or text messages. Further, the trainer may perform role modeling themselves.

In further embodiments, the trainer media may include a prompt portion. The prompt portion may be related to a situation to which the trainee needs to respond. For example, the prompt portion may be related to a situation where a customer says hello to the trainee. Further, capturing of the trainee media may be automatically initiated upon presentation of the prompt portion. In further embodiments, the trainer media further may include a model portion. The model portion may indicate the type of response expected for a corresponding prompt portion. In some embodiments, one or more of the prompt portion and the model portion may be associated with an interactive cue-point. Further, the interactive cue-point may be configured to present one or more of the prompt portion and the model portion based on a user interaction with the interactive cue-point. For example, a long trainer media may include multiple interactive cue-points corresponding to multiple prompt portions. Accordingly, a trainee may use one or more interactive cue-points in the multiple interactive cue-points to train for the respective prompt portions.

Further, at 306, the method 300 may include transmitting, using the communication device, the trainer media to a trainee device. In some embodiments, the trainee device may be media capturing device installed in the vicinity of the trainee. For example, the trainee device may be a CCTV camera installed in a facility.

Further, at 308, the method 300 may include receiving, using the communication device, a trainee media from the trainee device. At 310, the method 300 may include storing, using the storage device, the trainee media.

Further, at 312, the method 300 may include analyzing, using a processing device (such as the processing device 204), the trainee media. In some embodiments, the analyzing may include facial expression analysis, gesture analysis, body language analysis and so on. Further, in some embodiments, the analyzing may include voice analysis, speech analysis, language analysis and so on

Further, at 314, the method 300 may include generating, using the processing device, at least one trainee characteristic based on the analyzing of the trainee media. In some embodiments, the at least one trainee characteristic may include an emotional indicator, such as a type and intensity of one or more emotions expressed by the trainee in the trainee video. Thereafter, at 316, the method 300 may include transmitting, using the communication device, the at least one trainee characteristic to the trainee device.

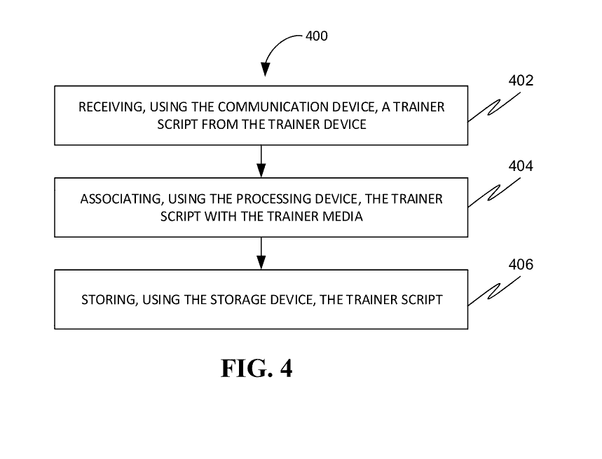

FIG. 4 is a flowchart of a method 400 of obtaining a trainer script, in accordance with some embodiments. At 402, the method 400 may include receiving, using the communication device, a trainer script from the trainer device. Further, at 404, the method 400 may include associating, using the processing device, the trainer script with the trainer media. Moreover, at 406, the method 400 may include storing, using the storage device, the trainer script. The trainer script may be transmitted to the trainee device along with the trainer media. Moreover, the trainer script may be presented to the trainee along with the trainer media.

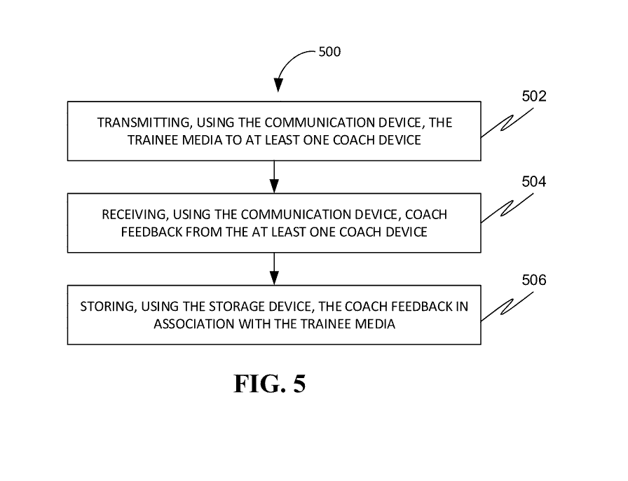

FIG. 5 is a flowchart of a method 500 of obtaining a manual feedback from a coach or a trainer, in accordance with some embodiments. At 502, the method 500 may include transmitting, using the communication device, the trainee media to at least one coach device. At 504, the method 500 may include receiving, using the communication device, coach feedback from the at least one coach device. At 506, the method 500 may include storing, using the storage device, the coach feedback in association with the trainee media.

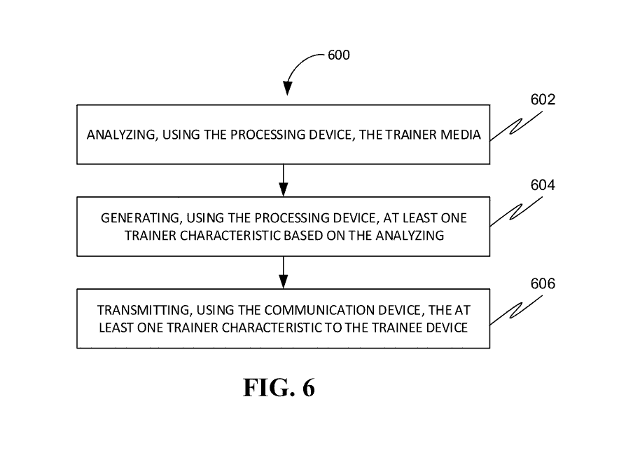

FIG. 6 is a flowchart of a method 600 of providing at least one trainer characteristic to a trainee device, in accordance with some embodiments. At 602, the method 600 may include analyzing, using the processing device, the trainer media. At 604, the method 600 may include generating, using the processing device, at least one trainer characteristic based on the analyzing. Moreover, at 604, the method 600 may include transmitting, using the communication device, the at least one trainer characteristic to the trainee device. The at least one trainer characteristic may provide another guide to the trainee.

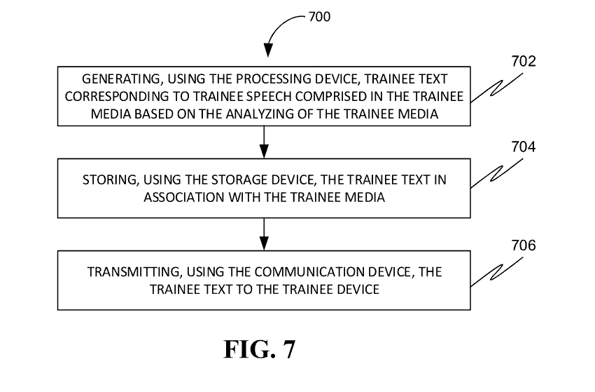

FIG. 7 is a flowchart of a method 700 of obtaining a trainee script, in accordance with some embodiments. At 702, the method 700 may include generating, using the processing device, trainee text corresponding to trainee speech comprised in the trainee media based on the analyzing of the trainee media. At 704, the method 700 may include storing, using the storage device, the trainee text in association with the trainee media. At 706, the method 700 may include transmitting, using the communication device, the trainee text to the trainee device.

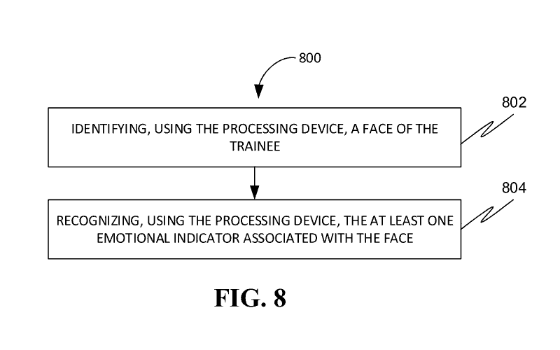

FIG. 8 is a flowchart of a method 800 of determining at least one emotional indicator in the at least one trainee characteristic, in accordance with some embodiments. At 802, the method 800 may include identifying, using the processing device, a face of the trainee. Further, at 802, the method 800 may include recognizing, using the processing device, the at least one emotional indicator associated with the face.

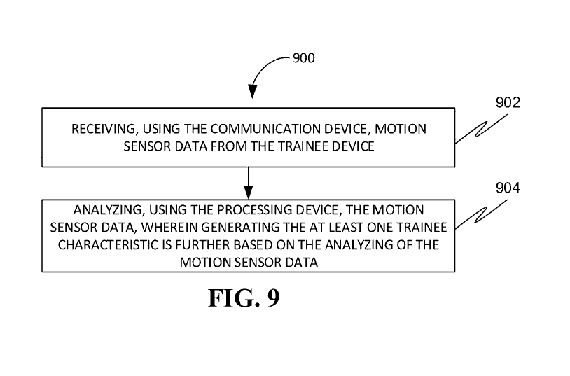

FIG. 9 is a flowchart of a method 900 of obtaining a motion sensor data from the trainee device, in accordance with some embodiments. For example, the motion sensor data may provide information about movements (such as hand movements, walking etc.) performed by the trainee. At 902, the method 900 may include receiving, using the communication device, the motion sensor data from the trainee device. Further, at 904, the method 900 may include analyzing, using the processing device, the motion sensor data. Further, generating the at least one trainee characteristic may be further based on the analyzing of the motion sensor data.

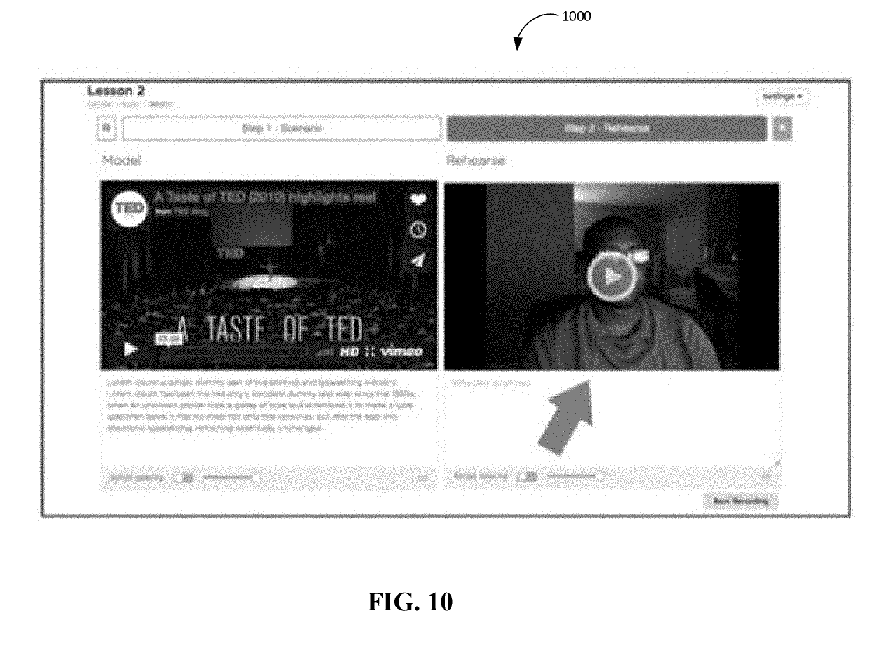

According to some embodiments, a video rehearser (vR) application is disclosed. The vR application may be hosted on the online platform 100. Further, the vR application may include one or more user interfaces shown in FIGS. 10-48.

FIG. 10 illustrates a user interface 1000 of the vR application that allows the trainee to navigate to a lesson, in accordance with an exemplary embodiment. For example, the trainee may select one or more available lesson types.

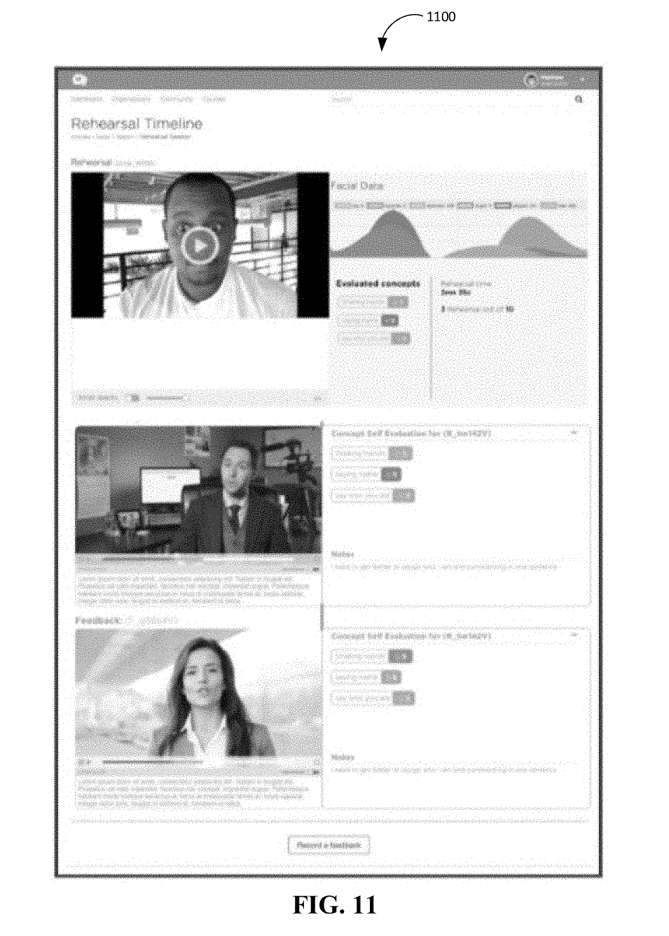

FIG. 11 illustrates a user interface 1100 of the vR application that allows the trainee to review his/her rehearsal timeline, in accordance with an exemplary embodiment. The rehearsal timeline may include emotional analysis to let the trainee know what emotions he/she showed throughout the rehearsal submission.

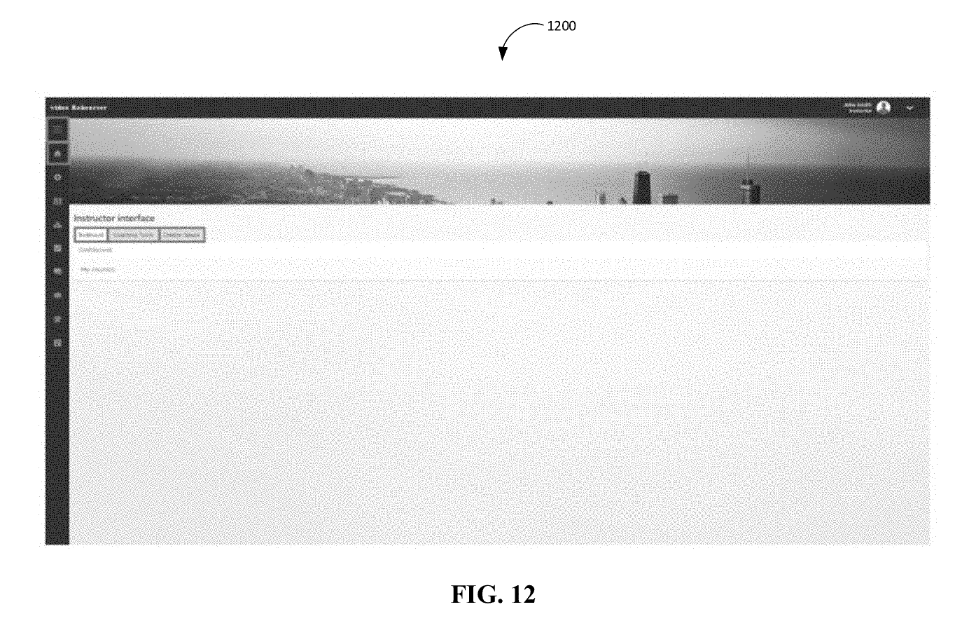

FIG. 12 illustrates a user interface 1200 of a home page of the vR application that allows the trainee to review his/her rehearsal timeline, in accordance with an exemplary embodiment. The home page may be shown when a user logs in the vR application From the home page, the user may be able to access a dashboard. This is one of the areas where a user may go to access your content and create content (courses, topics, and lessons). The left-hand side of the user interface 1200 may include a toolbar with a row of icons. Further, a toolbar may be always available, no matter where the user goes on the vR application.

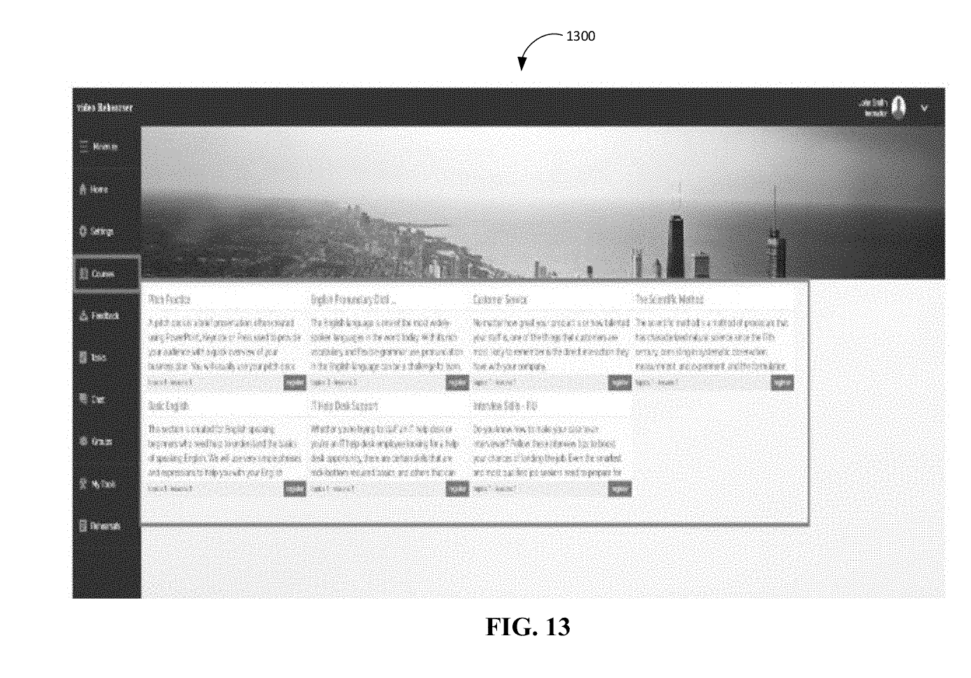

FIG. 13 illustrates a user interface 1300 related to a courses page of the vR application, in accordance with an exemplary embodiment. The courses page allows the user to view and browse courses. Further, depending on the privacy settings selected by the user, courses created by the user may appear on this page.

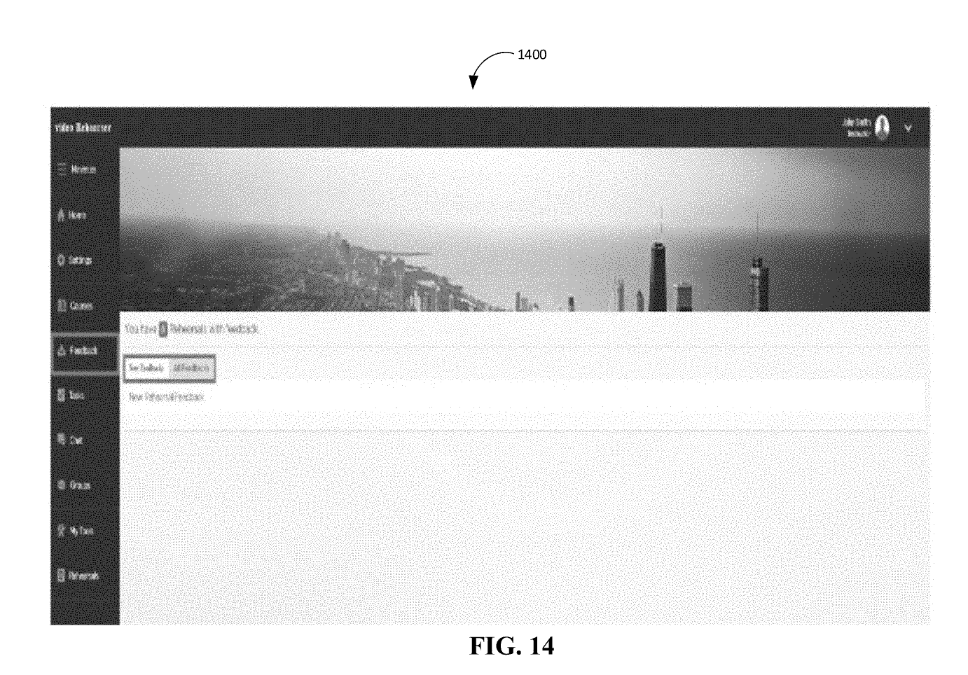

FIG. 14 illustrates a user interface 1400 related to a feedback page of the vR application, in accordance with an exemplary embodiment. When trainees submit a rehearsal, the trainers may be required to provide them with feedback The feedback page is where the trainers may go to take a look at the feedback provided to the trainees for both the new and the old rehearsals. This may work the same way in the trainee interface.

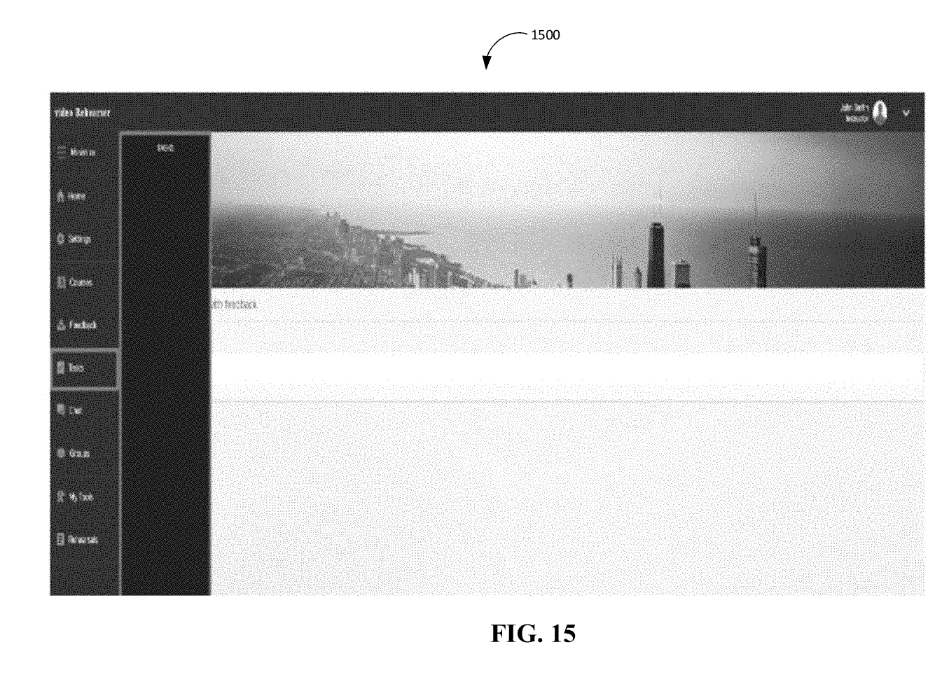

FIG. 15 illustrates a user interface 1500 related to a task page of the vR application, in accordance with an exemplary embodiment. The task page may appear when the user clicks on a tasks icon the toolbar. The task page allows the trainer to assign tasks to trainees that need to be completed. The trainees may go their task page to view the tasks assigned to them.

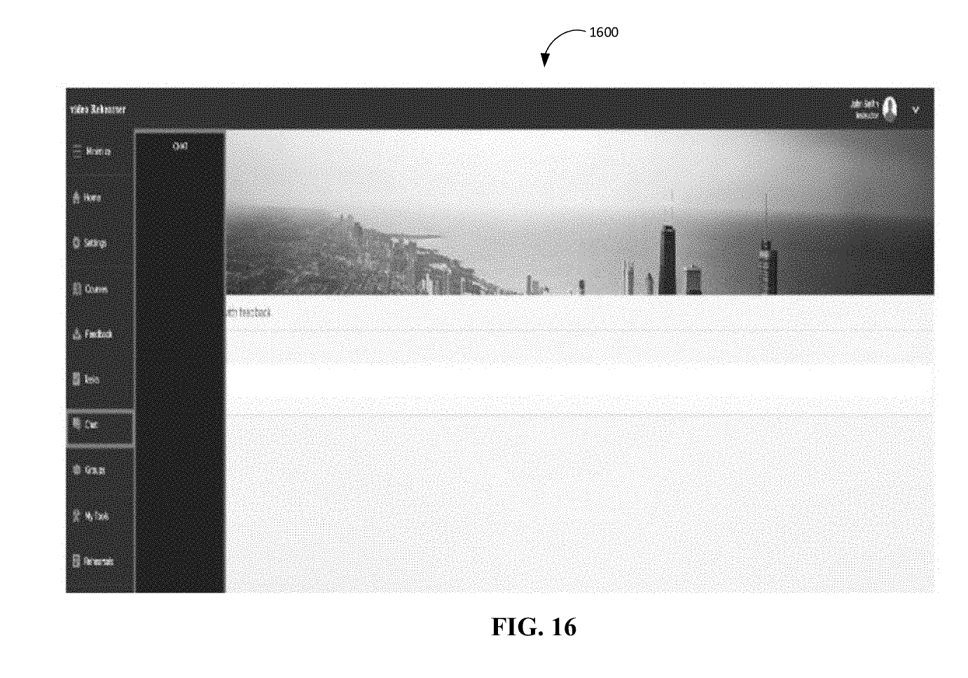

FIG. 16 illustrates a user interface 1600 related to a chat page of the vR application, in accordance with an exemplary embodiment. The chat page may allow users to chat with one another.

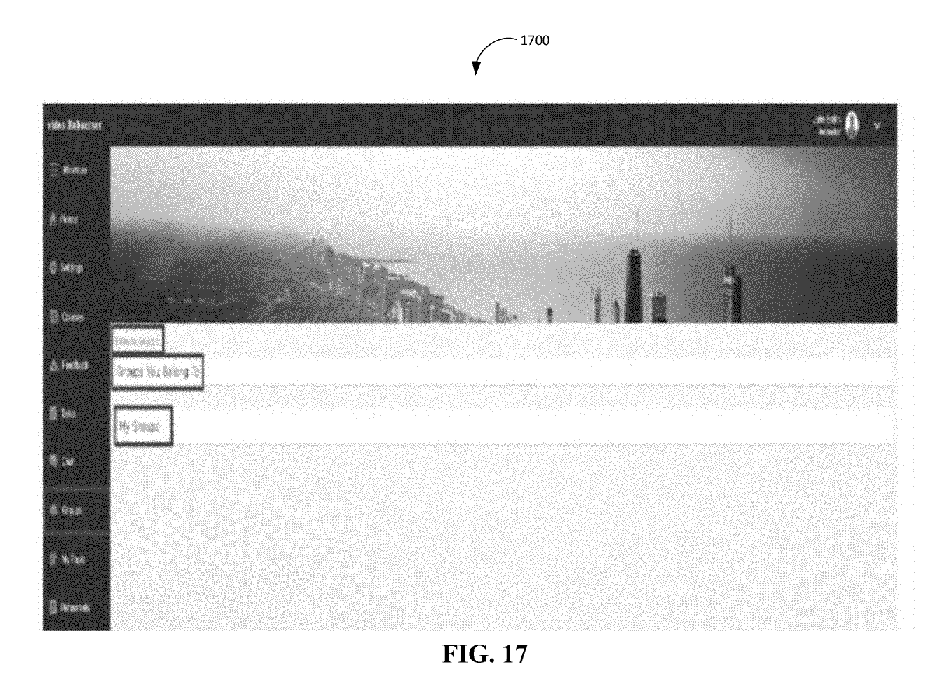

FIG. 17 illustrates a user interface 1700 related to a groups page of the vR application, in accordance with an exemplary embodiment. The groups page is where the users you may find groups and access the groups they belong to.

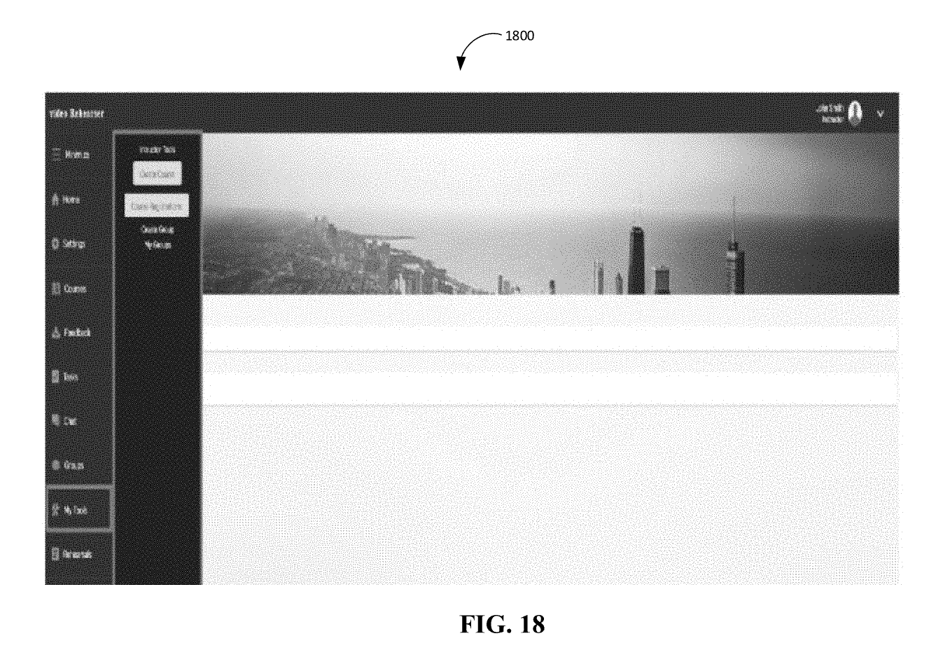

FIG. 18 illustrates a user interface 1800 related to a “my tools” page of the vR application, in accordance with an exemplary embodiment. The “my tools” page may allow trainers to create and manage their courses.

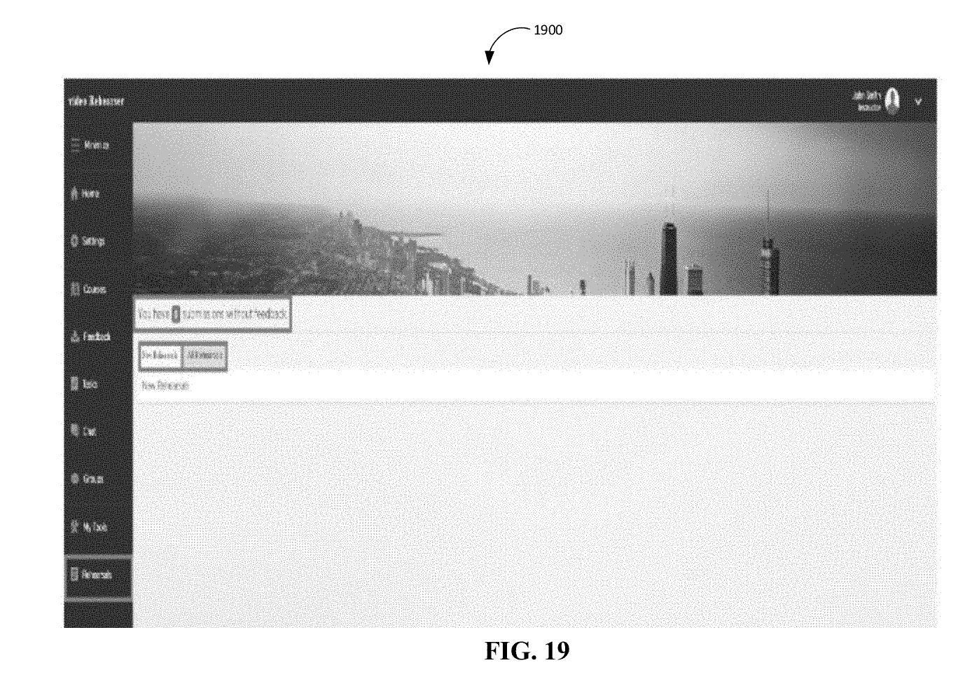

FIG. 19 illustrates a user interface 1900 related to a rehearsals page of the vR application, in accordance with an exemplary embodiment. The rehearsals page allows the trainees to manage submissions made by them and keep track the submissions that need feedback.

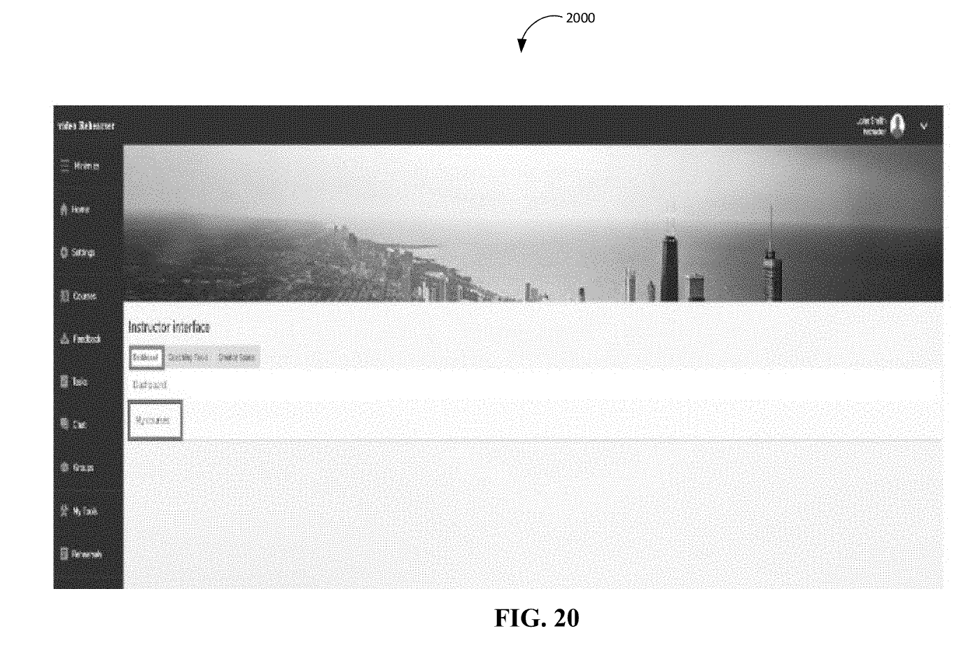

FIG. 20 illustrates a user interface 2000 related to an instructor interface of the vR application, in accordance with an exemplary embodiment. The instructor interface includes a dashboard tab. The dashboard tab displays “My Courses” for the users. Courses you create can be found in this space.

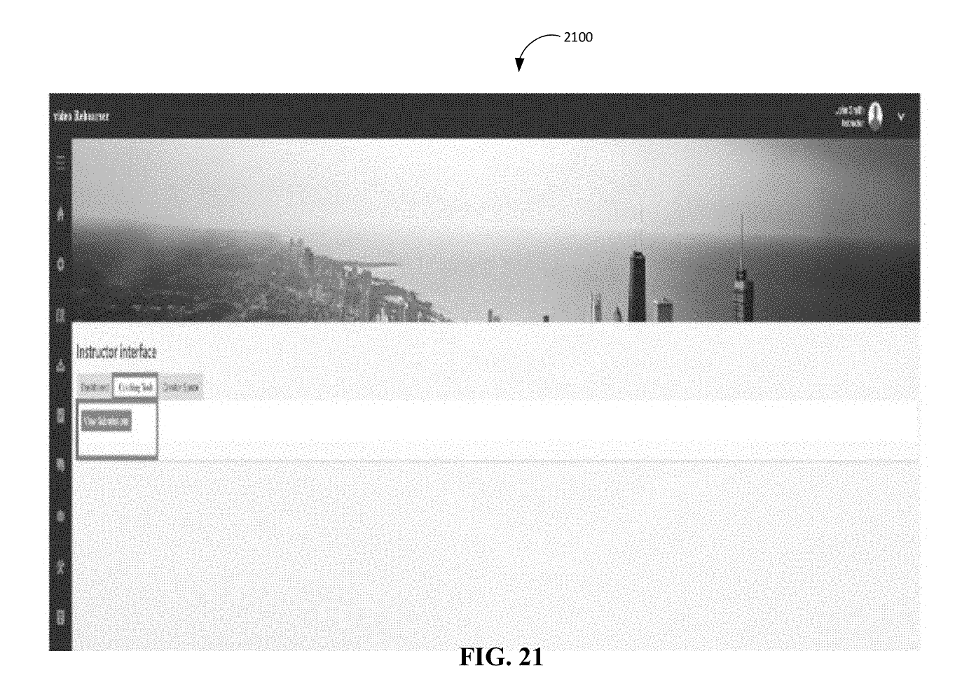

FIG. 21 illustrates a user interface 2100 related to a “Coaching Tools” tab on the instructor interface of the vR application, in accordance with an exemplary embodiment. The “Coaching Tools” tab provides an interface where the trainers may access and view trainees' submissions.

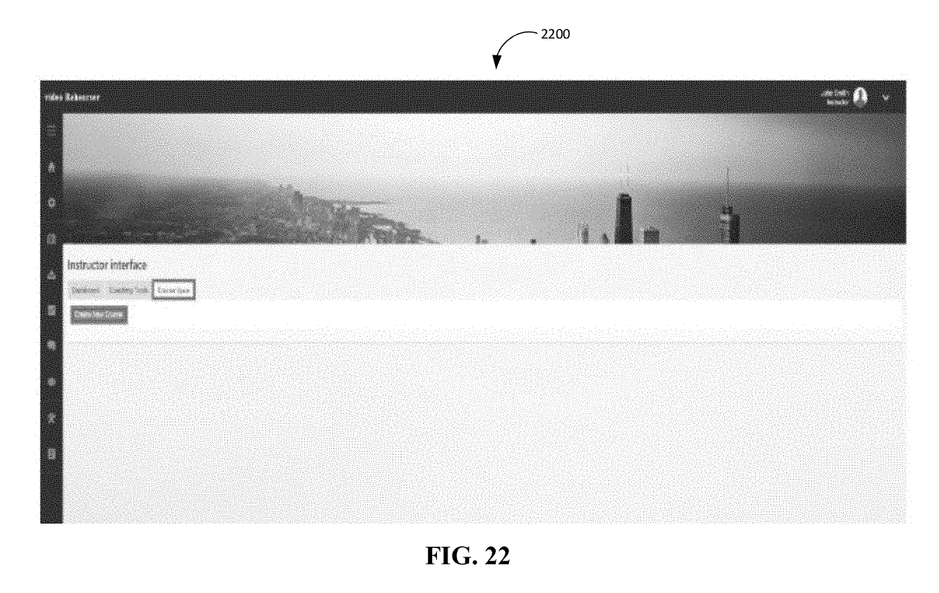

FIG. 22 illustrates a user interface 2200 related to a “Creator Space” tab on the instructor interface of the vR application, in accordance with an exemplary embodiment. The “Coaching Tools” tab allows trainers to create courses. The three components make up a course include a course, a topic and a lesson. A trainer may click a button labeled Create New Course to create a new course.

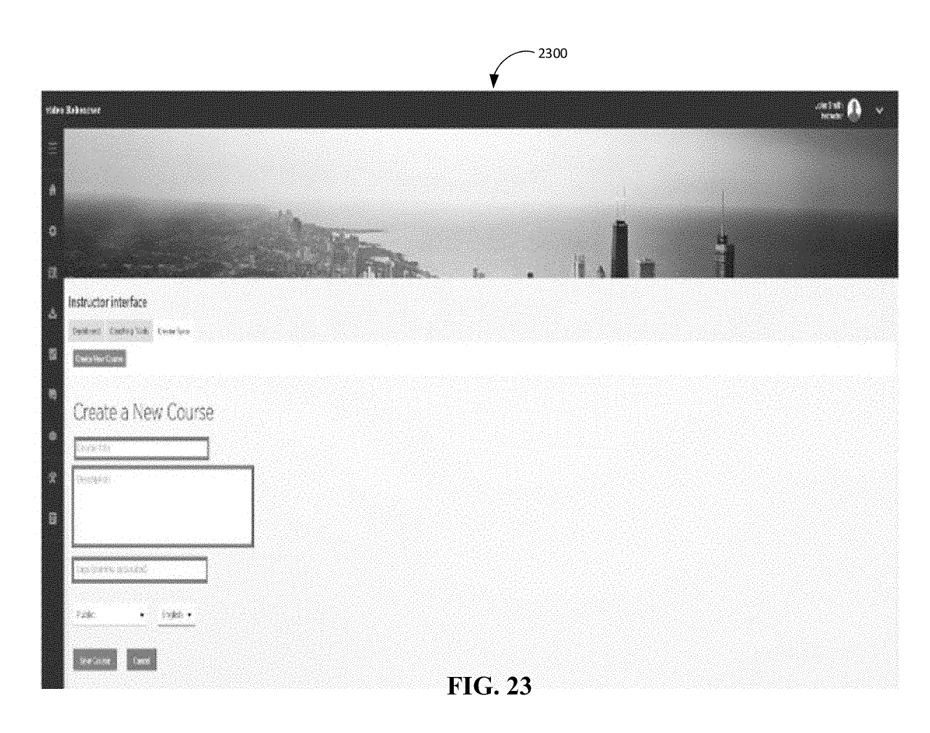

FIG. 23 illustrates a user interface 2300 related to a “create course” page of the vR application, in accordance with an exemplary embodiment. The “create course” page allows a trainer to create a course using a form. The form may include one or more fields—Course Title, Course Description, Tags.

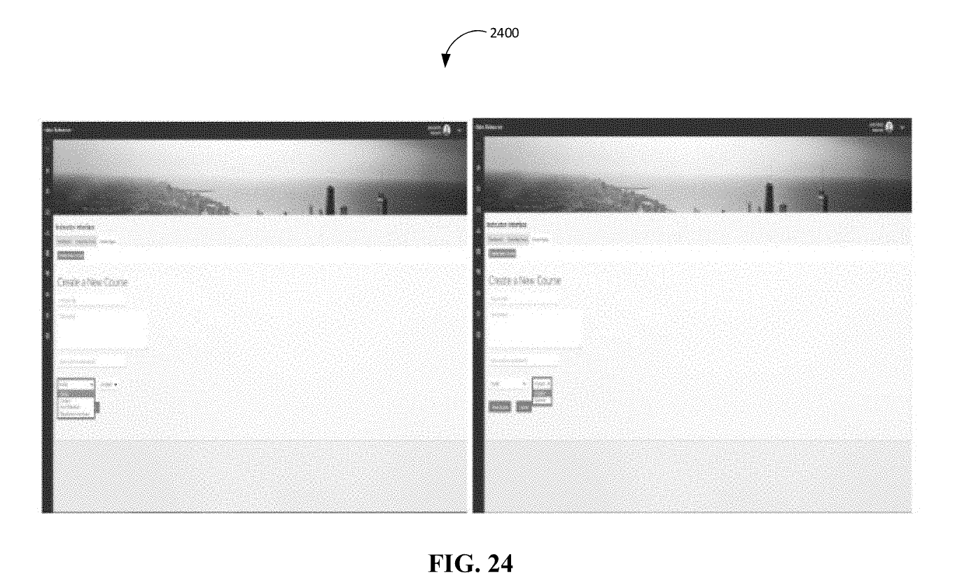

FIG. 24 illustrates user interfaces related to privacy and language options for a course, in accordance with an exemplary embodiment. Accordingly, two drop down menus may be provided: one for privacy settings and the other for language options. The privacy setting menu may allow the trainer to select one of public, locked, paid members and registered members. The language options menu may allow the trainer to select one of English and Spanish.

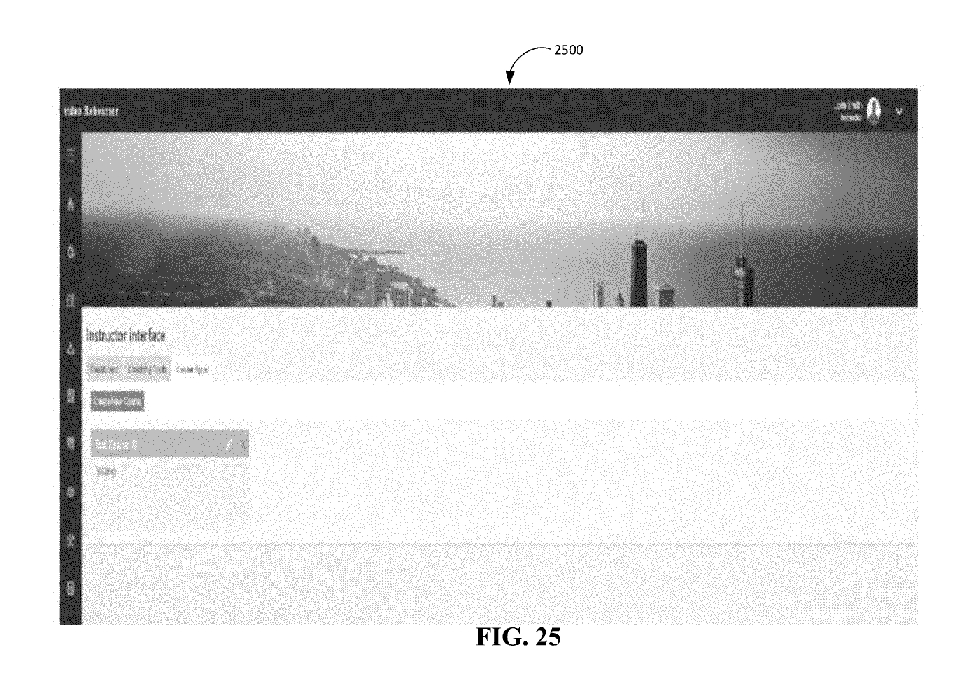

FIG. 25 illustrates a user interface 2500 related to the “Creator Space” tab of the vR application, in accordance with an exemplary embodiment. When the trainer selects the privacy and language settings, the corresponding course appears below button labeled Create New Course.

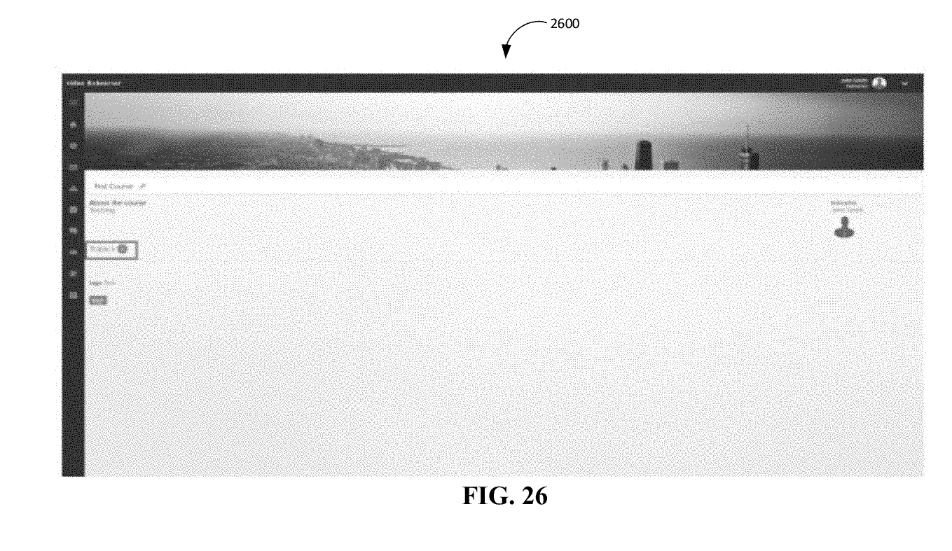

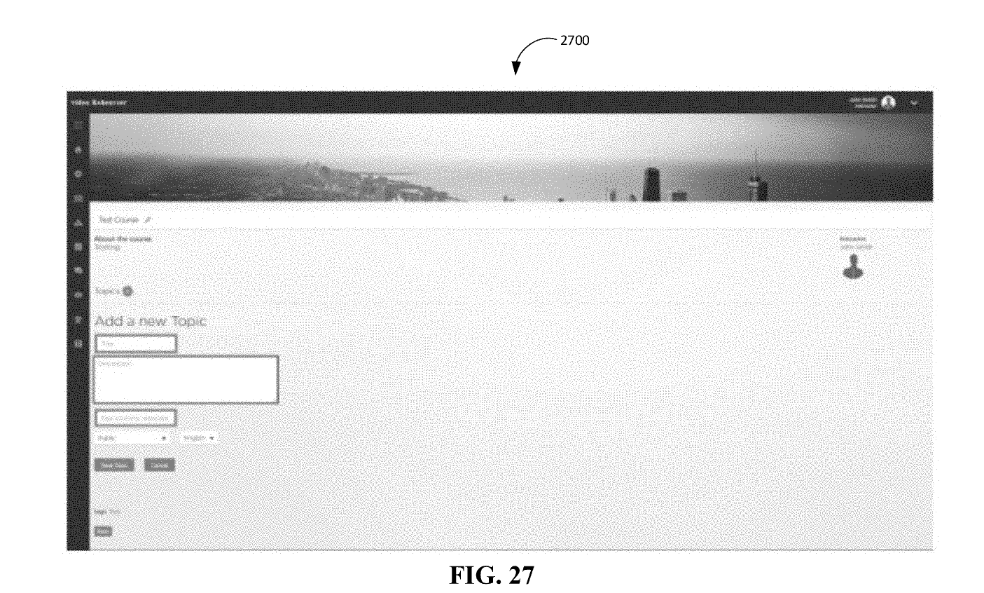

FIG. 26 illustrates a user interface 2600 related to a “Create Topic” page of the vR application, in accordance with an exemplary embodiment. After creating a course, the trainer may create a topic using the “Create Topic” page. The trainer may fill a form and select privacy and language settings for a topic. FIG. 27 illustrates a user interface 2700 related to a Topics page of the vR application, in accordance with an exemplary embodiment. The topics page may list the created topics.

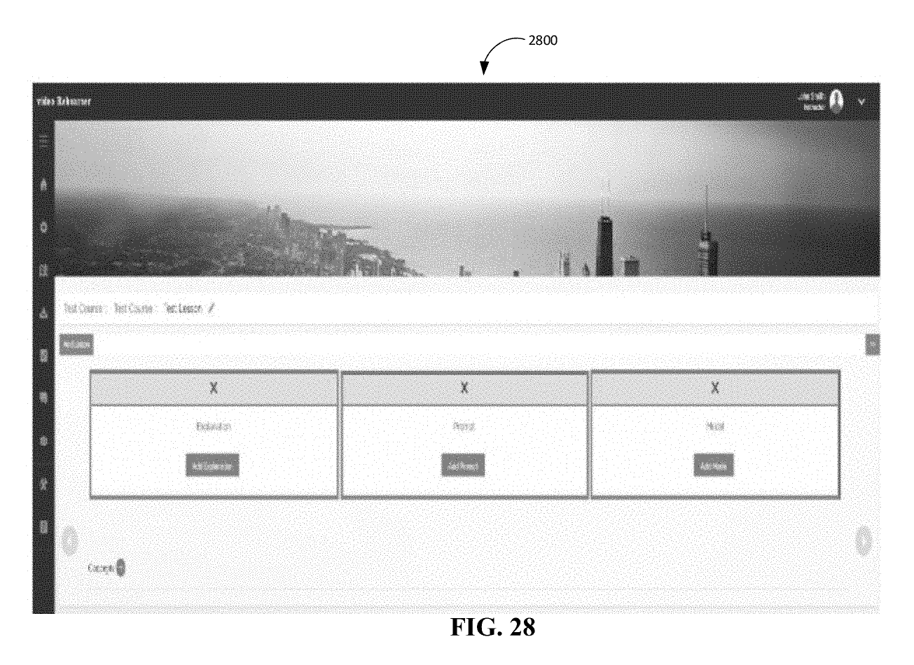

FIG. 28 illustrates a user interface 2800 related to an EPM page of the vR application, in accordance with an exemplary embodiment. The EPM page allows the trainer to create an Explanation, a Prompt and a Model (Role Model).

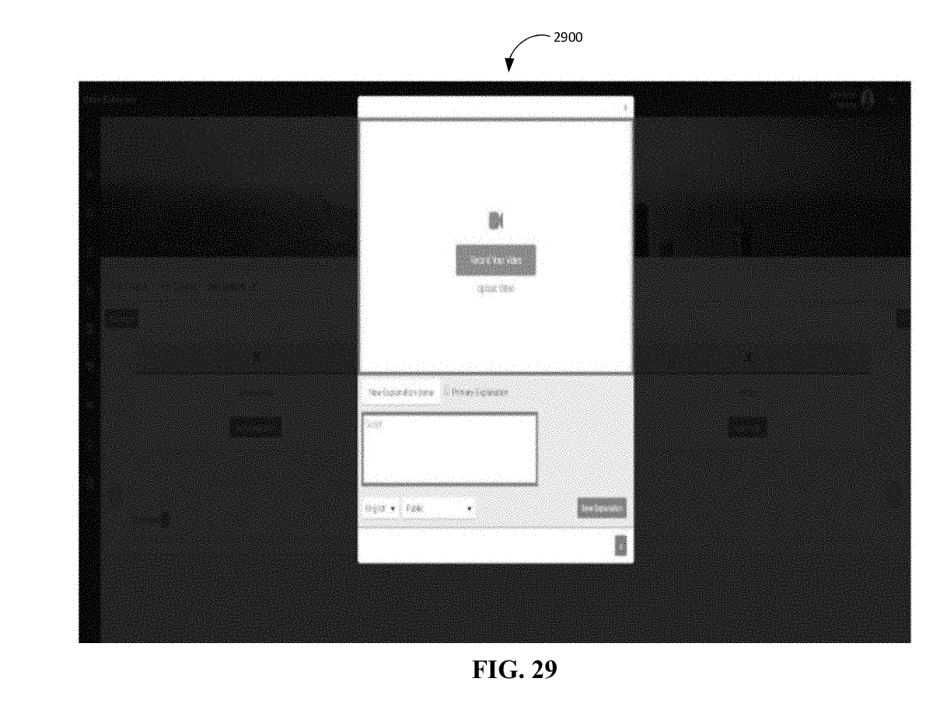

FIG. 29 illustrates a user interface 2900 related to an Explanation page of the vR application, in accordance with an exemplary embodiment. The explanation sets up the stage for the scenario the trainees will be rehearsing for. When the trainer clicks on “Add Explanation” a video player may pop up on your screen.

Further, there may be two ways you can go about posting your explanation. Frist, the trainer may upload a pre-recorded video and type out the script in the script box. Second, the trainer may write out a script first in the script box and record themselves via the video player. Both of these methods apply to the prompt and model.

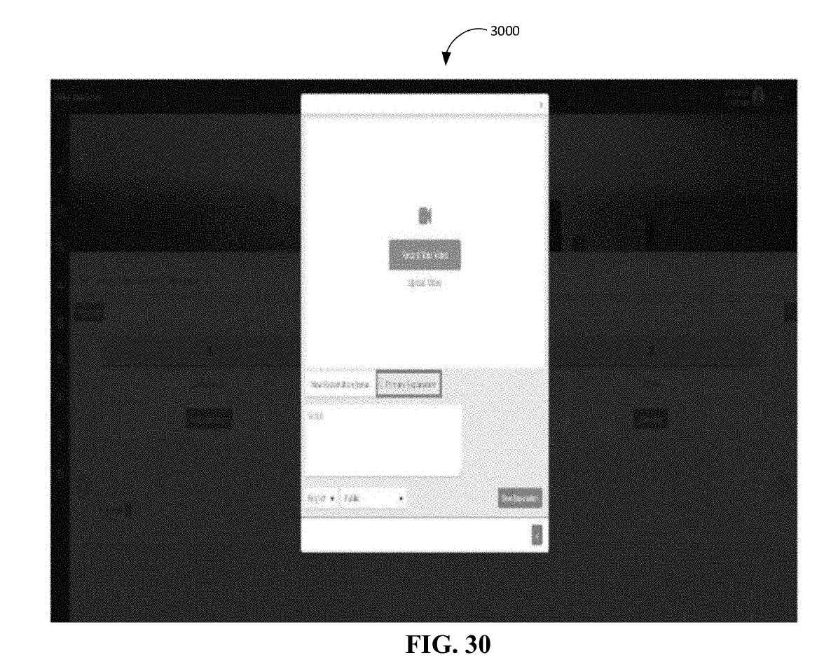

FIG. 30 illustrates a user interface 3000 related to a primary explanation page of the vR application, in accordance with an exemplary embodiment. The trainer may have more than one explanation but only one can be the primary. The trainer of the course must select a primary explanation. The same goes for the prompt and model.

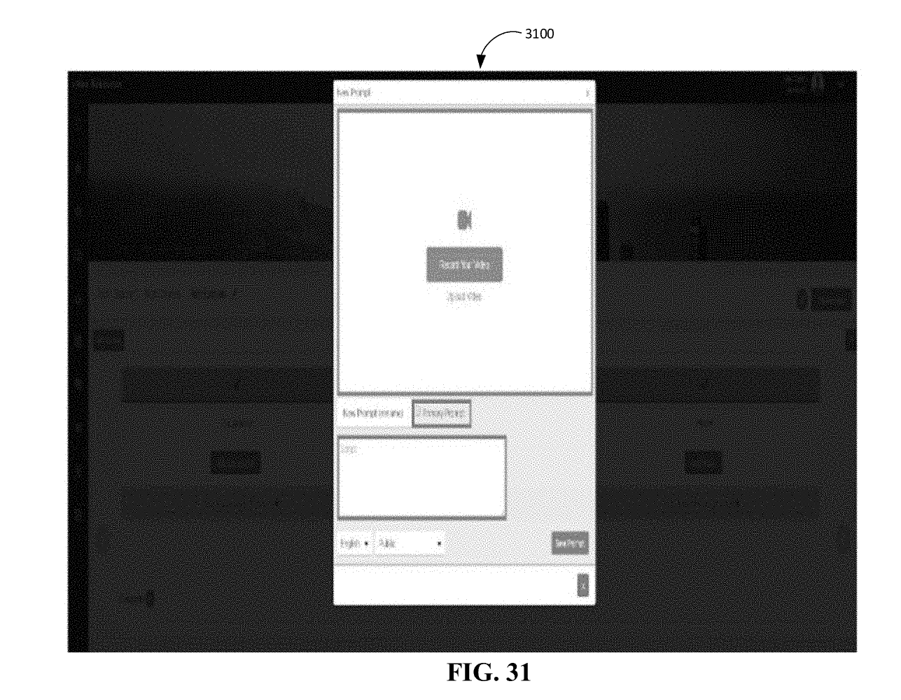

FIG. 31 illustrates a user interface 3100 related to a prompt page of the vR application, in accordance with an exemplary embodiment. The prompt page may allow the trainer to add a prompt. Both the prompt and model go hand in hand for the trainee as they will see both when they reach the demonstration portion of the lesson. The prompt may be an example of a scenario they will need to respond to.

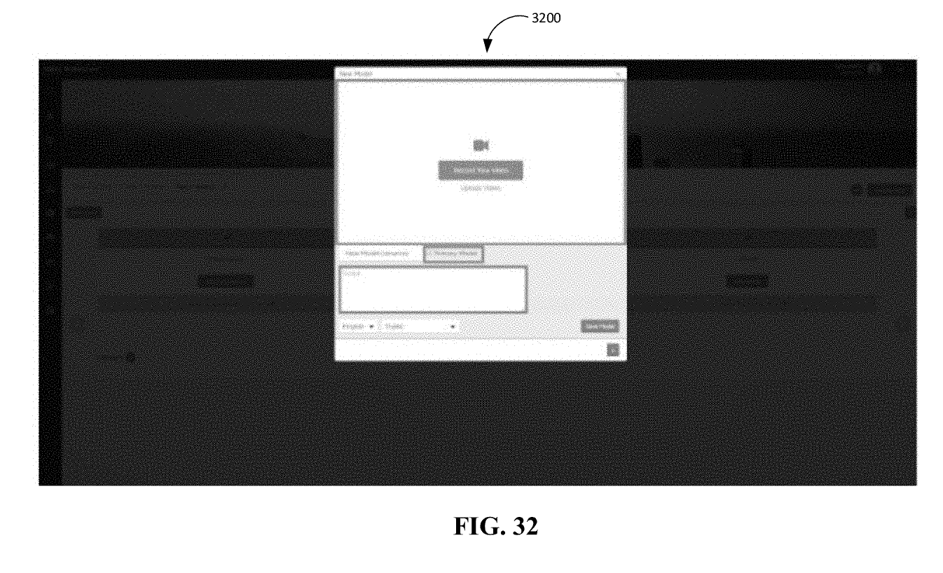

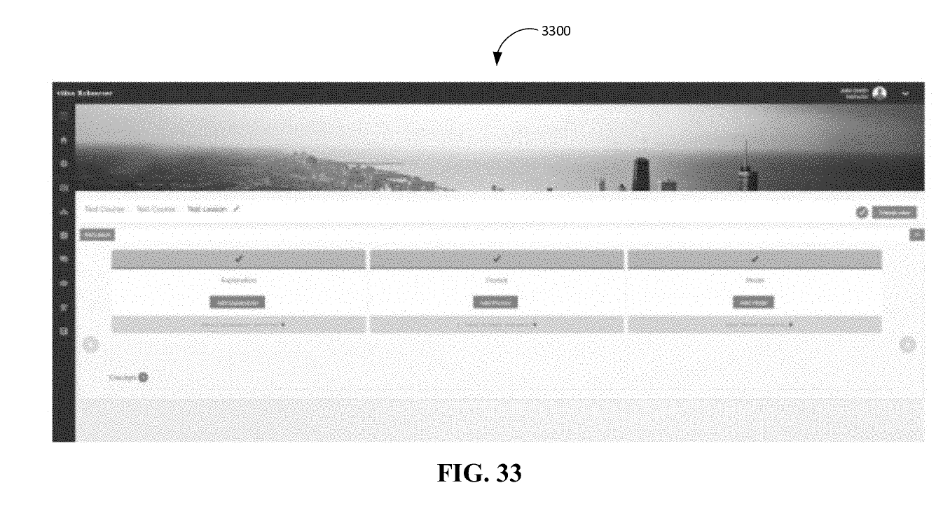

FIG. 32 illustrates a user interface 3200 related to a model page of the vR application, in accordance with an exemplary embodiment. The model is an example of how they should respond to the prompt. When an explanation, prompt, and model is created, a user interface 3300 (FIG. 33) may be shown.

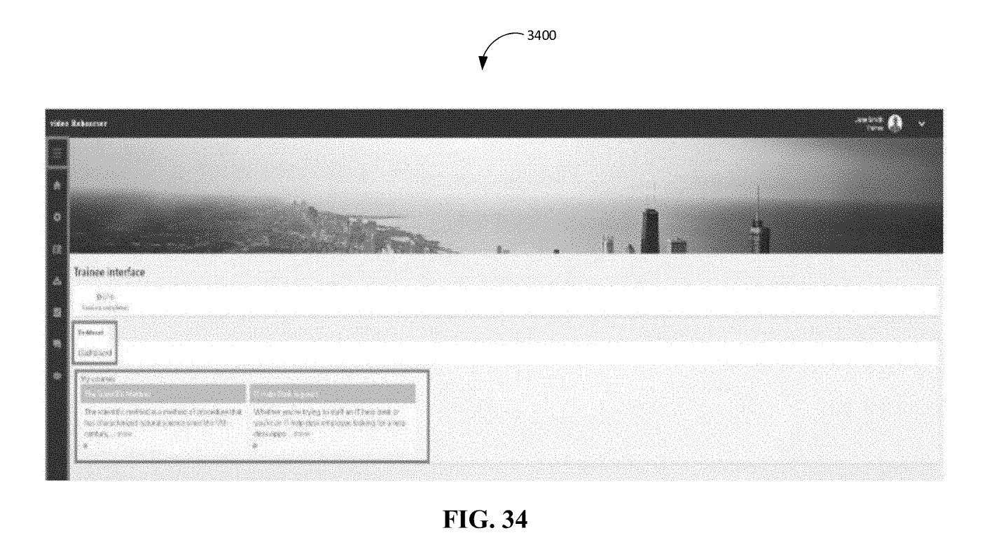

FIG. 34 illustrates a user interface 3400 related to a home page (of the trainee) of the vR application, in accordance with an exemplary embodiment. The home page includes a list of courses that the trainee is currently enrolled in (my courses).

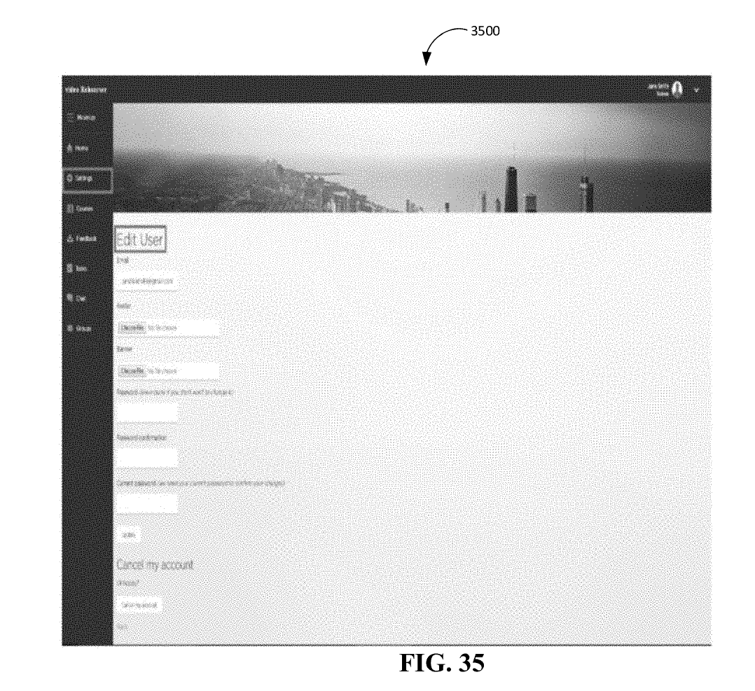

FIG. 35 illustrates a user interface 3500 of a settings page of the vR application, in accordance with an exemplary embodiment. The user may click on a gear icon on the toolbar to go to the settings page. The settings page may allow the user to perform one or more of change email, change avatar, change banner, change password and cancel account.

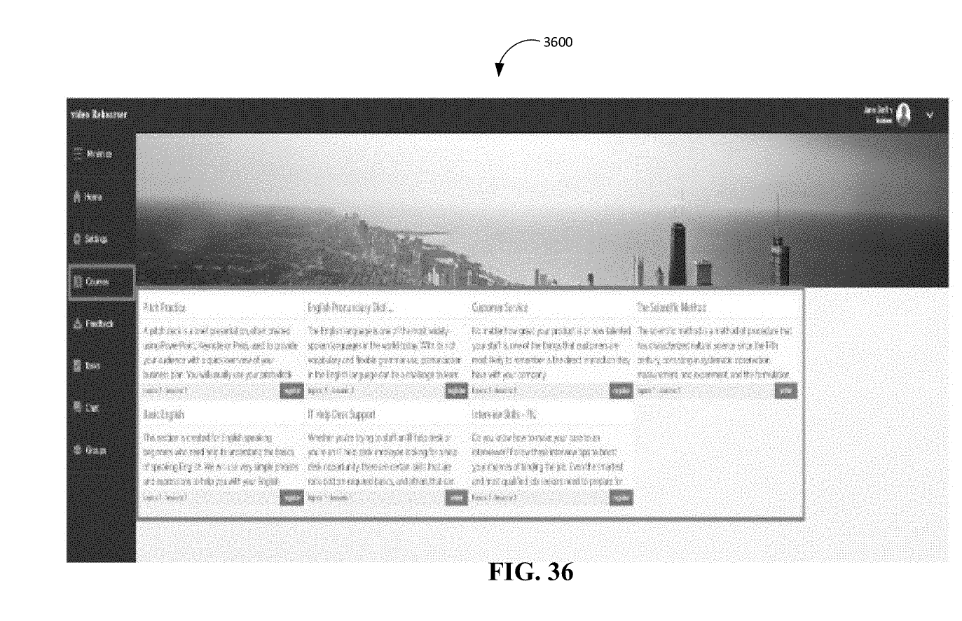

FIG. 36 illustrates a user interface 3600 of a course page of the vR application, in accordance with an exemplary embodiment. The course page may allow users to view courses that are available, select a course, and register for a course.

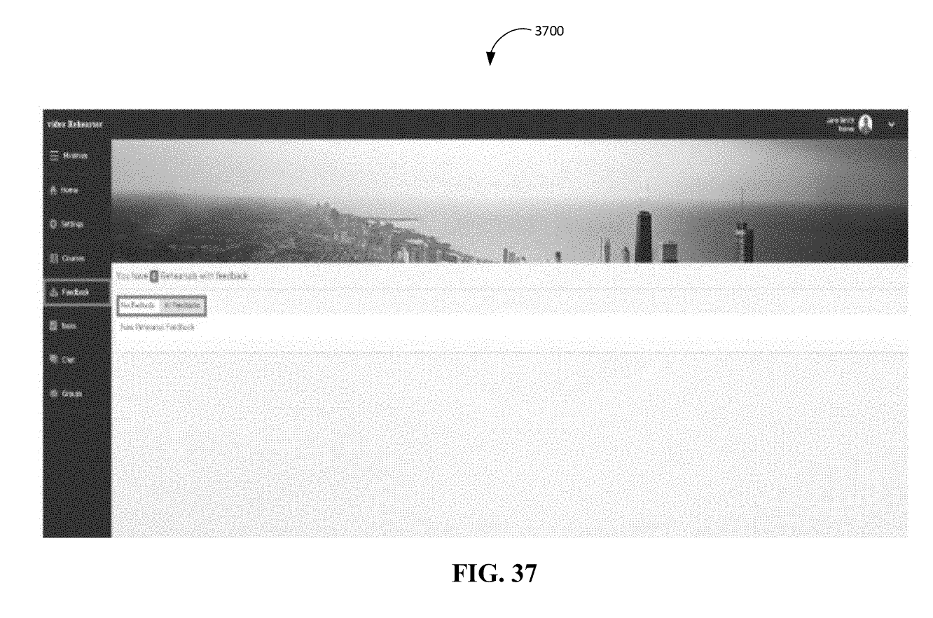

FIG. 37 illustrates a user interface 3700 related to a feedback page of the vR application, in accordance with an exemplary embodiment. When trainees submit a rehearsal, the trainers may be required to provide them with feedback The feedback page is where the trainers may go to take a look at the feedback provided to the trainees for both the new and the old rehearsals.

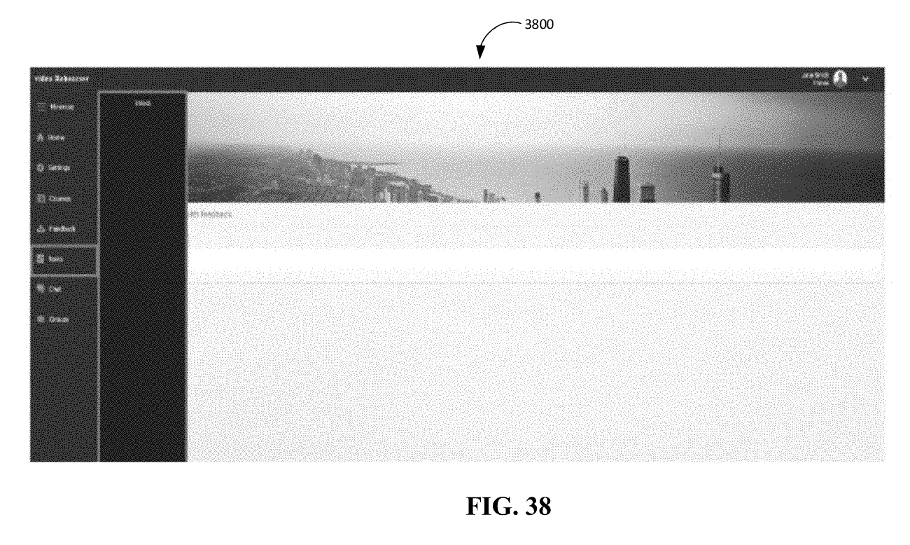

FIG. 38 illustrates a user interface 3800 related to a task page of the vR application, in accordance with an exemplary embodiment. The task page may appear when the user clicks on a tasks icon the toolbar. The task page allows the trainees to view the tasks assigned to them.

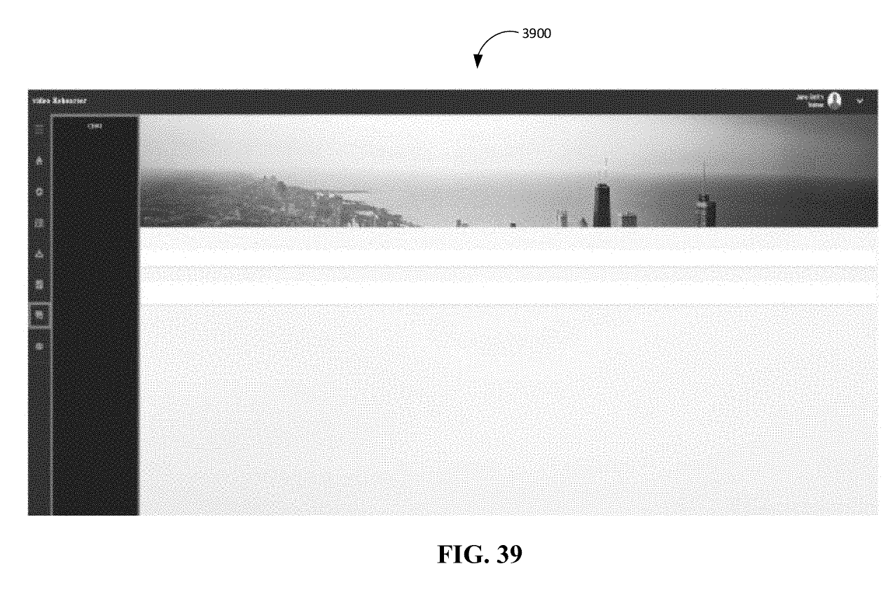

FIG. 39 illustrates a user interface 3900 related to a chat page of the vR application, in accordance with an exemplary embodiment. The chat page may allow users to chat with one another.

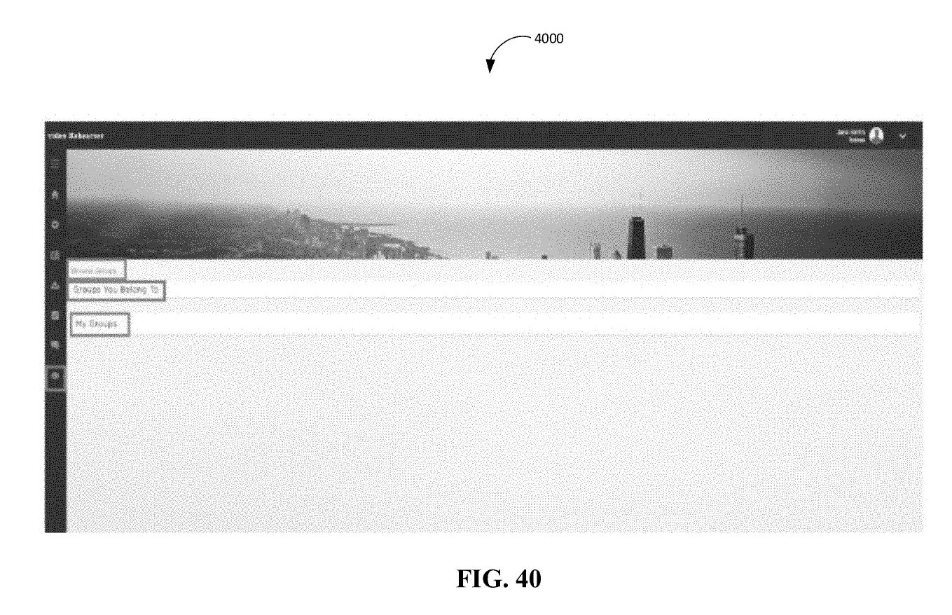

FIG. 40 illustrates a user interface 4000 related to a groups page of the vR application, in accordance with an exemplary embodiment. The groups page is where the users you may find groups and access the groups they belong to.

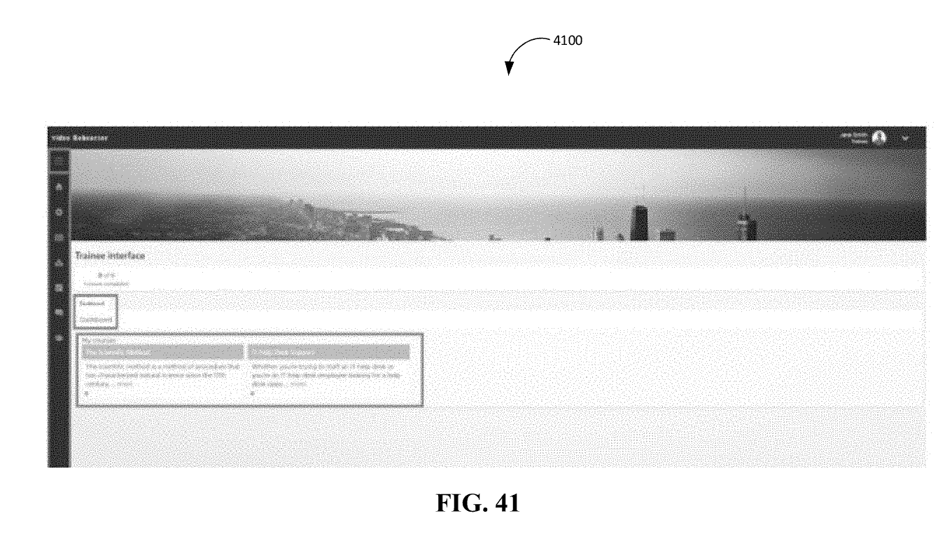

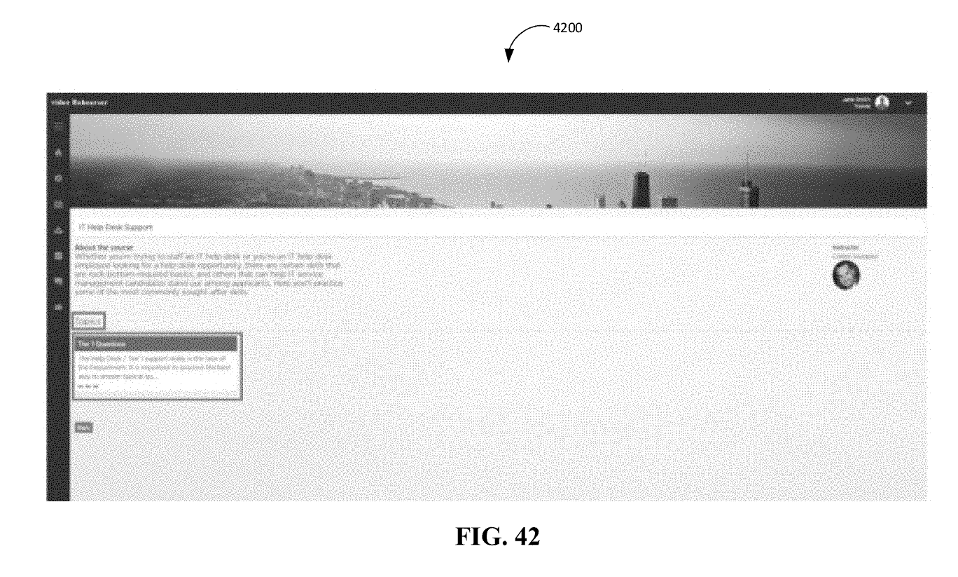

FIG. 41 illustrates a user interface 4100 related to the home page of the vR application, in accordance with an exemplary embodiment. Before a trainee can record a rehearsal, they need to select which course they wish to record one for. Once the trainee selects a course, then they will need to choose a topic, as shown in a user interface 4200 (refer to FIG. 42) related to the topics page of the vR application.

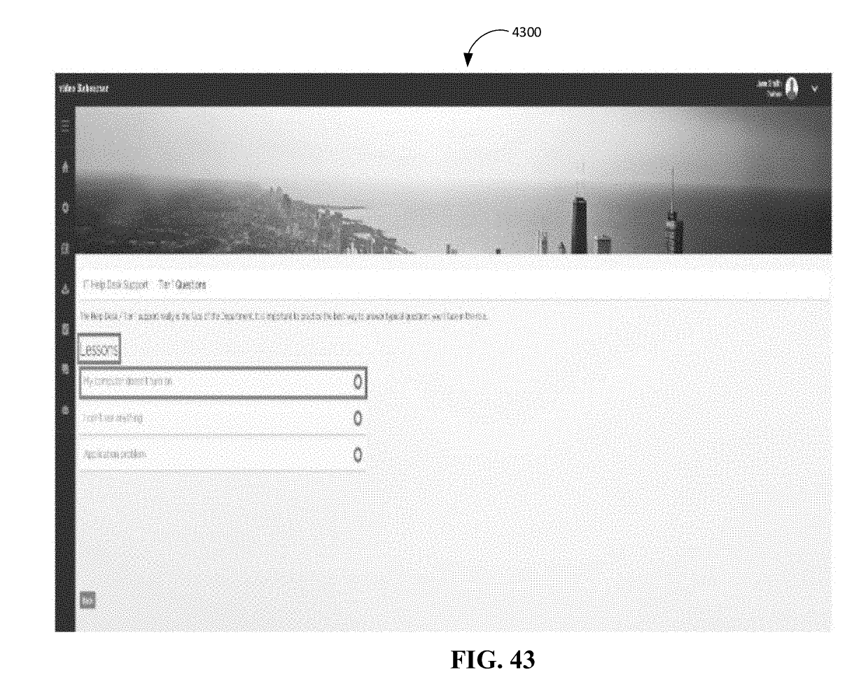

Depending on the selected topic, there can be numerous lessons for each one. Then, the trainee may select the first lesson on the list shown in a user interface 4300 (refer to FIG. 43) related to a lesson page of the vR application, in accordance with an exemplary embodiment.

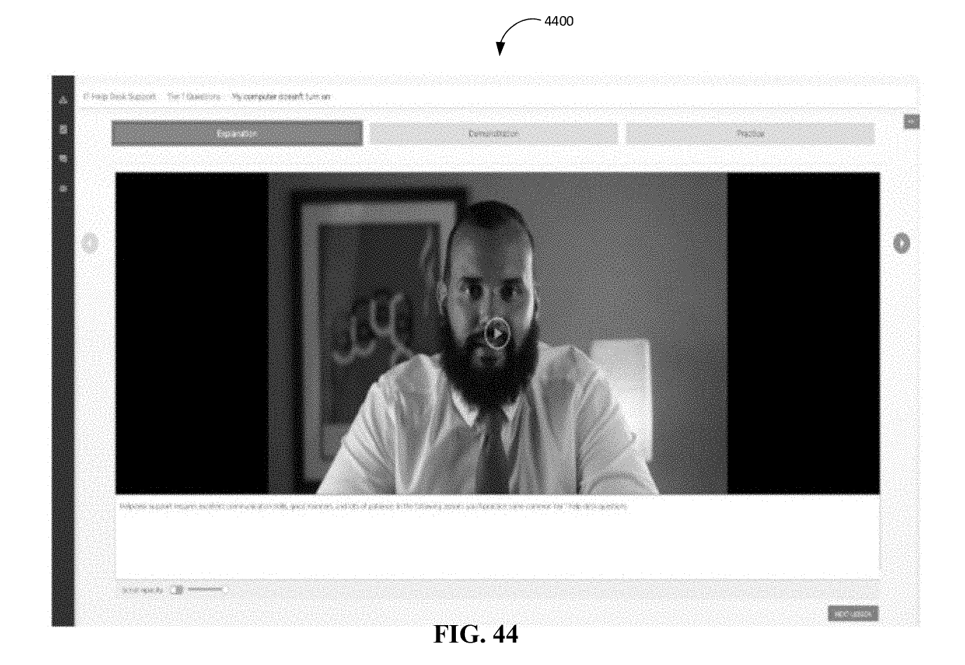

FIG. 44 illustrates a user interface 4400 related to an explanation page of the vR application, in accordance with an exemplary embodiment. A first step in a lesson is to watch an explanation. Depending on the selected course/topic, the explanation page sets up the stage for a scenario that the trainee will be rehearsing for.

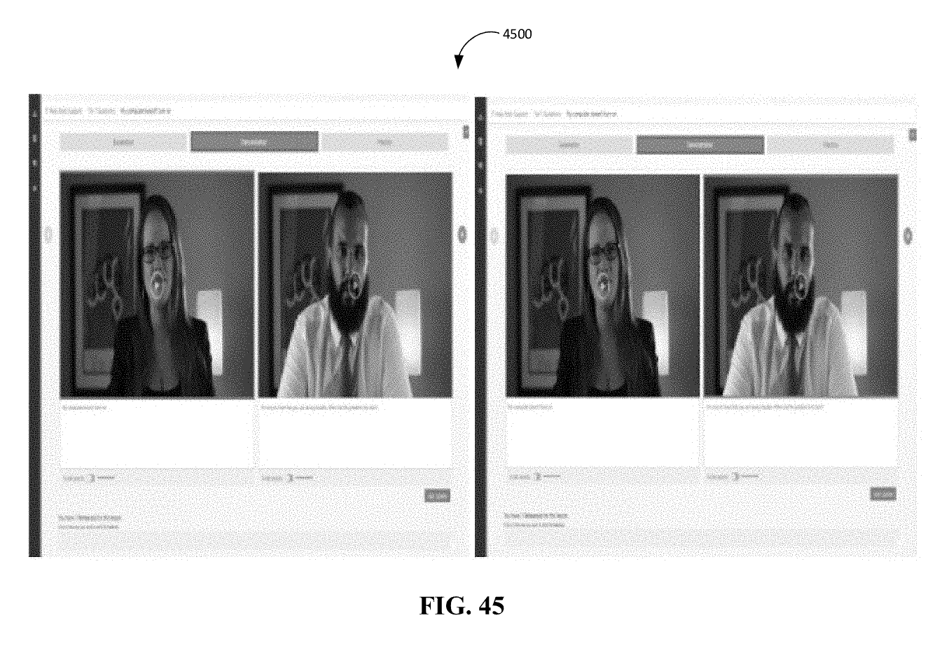

FIG. 45 illustrates a user interface 4500 related to a demonstration page of the vR application, in accordance with an exemplary embodiment. Once the trainee watches the explanation, they will then need to watch the demonstration. This is split into two videos. The one on the left gives an example of a scenario that the trainee will need to respond to. The one on the right is an example of how the trainee should respond. The trainee may see this same example when they move on to the practice portion of the lesson. Once the first video finishes playing (the one on the left) the next one (the one on the right) may automatically begin to play.

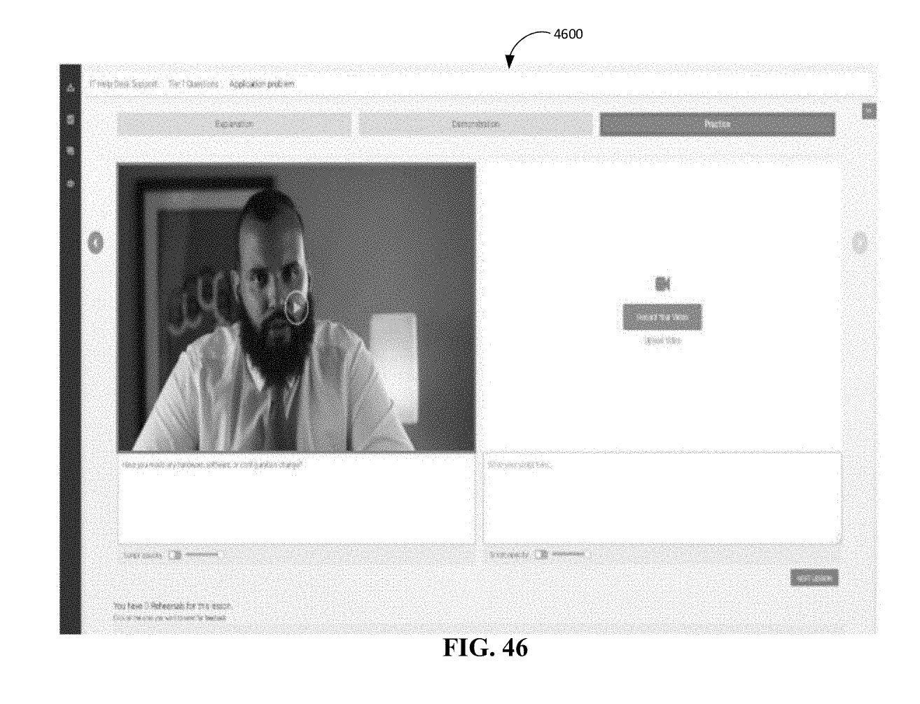

FIG. 46 illustrates a user interface 4600 related to a practice page of the vR application, in accordance with an exemplary embodiment. The trainees record their rehearsal on the practice page. Further, the demonstration video that showed how the trainee should respond appears on the left-hand side of the screen. When the demonstration video finishes playing, the trainee may proceed to the video player on the right and click on record your video.

Once the trainee finishes recording a rehearsal, they may be asked to select a thumbnail. Then, the rehearsal may be submitted to the trainer for feedback. There may be three ways to submit rehearsal. A trainee may write out their own response to the demonstration and use a script box as a teleprompter as they record their rehearsal. Further, the trainee may rehearse the response from an example video. Further, the trainee may upload a video file.

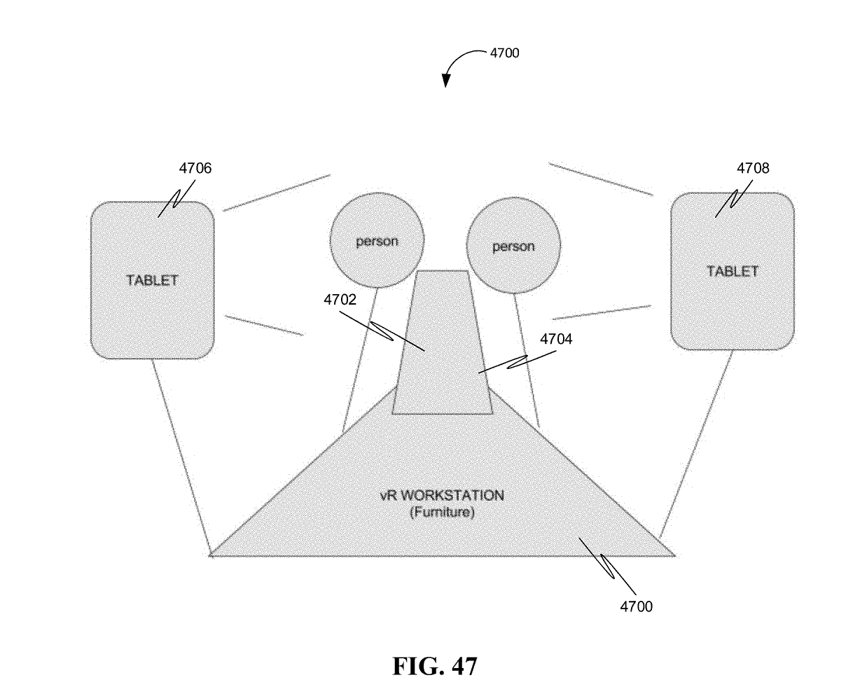

FIG. 47 illustrates a vR workstation 4700, in accordance with an exemplary embodiment. The vR workstation 4700 may include a microprocessor hardware, software and a furniture unit. The purpose of the vR workstation 4700 is to provide one touch operability and reliability of vR functionality. Further, the vR workstation 4700 may include two monitors 4702-4704, which may be arranged at an angle such as at 360°, 180°, 90°, and 45°. This may allow visualization for two people sitting at a square table at all possible sides. Further, the vR workstation 4700 may include two zoom capable cameras 4706-4708 to provide close-up and wide view for each person. Further, the vR workstation 4700 may include 2-4 microphones for a narrow pick up. Moreover, the vR workstation 4700 may include 1-2 mice, keyboard, and touchpads for interaction. Further, the vR workstation 4700 may include a color photo printer for premiums and incentives. The vR workstation 4700 may be available in an enclosure and may “pop out” like a standing desk. The vR workstation 4700 allow two people (trainer/trainer) to easily engage in a vR interaction with or without an internet connection.

For example, the two people may go into a conference room sit down at a table and open “vR Facilitation Interaction Box” hit a button and engage in their vR facilitated interaction. Further, the two people in the field (such as a coffee shop) they pull out the vR facilitated interpersonal skills facilitated interaction.

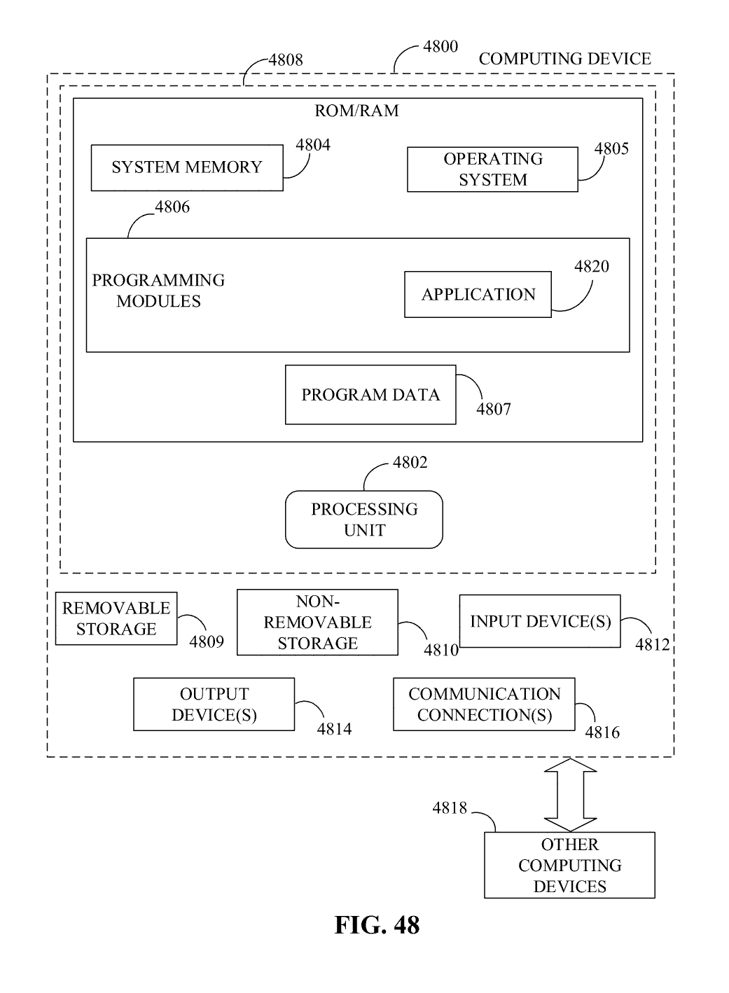

FIG. 48 is a block diagram of a computing device for implementing the methods disclosed herein, in accordance with some embodiments. Consistent with an embodiment of the disclosure, the aforementioned storage device and processing device may be implemented in a computing device, such as computing device 4800 of FIG. 48. Any suitable combination of hardware, software, or firmware may be used to implement the memory storage and processing unit. For example, the storage device and the processing device may be implemented with computing device 4800 or any of other computing devices 4818, in combination with computing device 4800. The aforementioned system, device, and processors are examples and other systems, devices, and processors may comprise the aforementioned storage device and processing device, consistent with embodiments of the disclosure.

With reference to FIG. 48, a system consistent with an embodiment of the disclosure may include a computing device or cloud service, such as computing device 4800. In a basic configuration, computing device 4800 may include at least one processing unit 4802 and a system memory 4804. Depending on the configuration and type of computing device, system memory 4804 may comprise, but is not limited to, volatile (e.g. random access memory (RAM)), non-volatile (e.g. read-only memory (ROM)), flash memory, or any combination. System memory 4804 may include operating system 4805, one or more programming modules 4806, and may include a program data 4807. Operating system 4805, for example, may be suitable for controlling computing device 4800's operation. Furthermore, embodiments of the disclosure may be practiced in conjunction with a graphics library, other operating systems, or any other application program and is not limited to any particular application or system. This basic configuration is illustrated in FIG. 48 by those components within a dashed line 4808.

Computing device 4800 may have additional features or functionality. For example, computing device 4800 may also include additional data storage devices (removable and/or non-removable) such as, for example, magnetic disks, optical disks, or tape. Such additional storage is illustrated in FIG. 48 by a removable storage 4809 and a non-removable storage 4810. Computer storage media may include volatile and nonvolatile, removable and non-removable media implemented in any method or technology for storage of information, such as computer-readable instructions, data structures, program modules, or other data. System memory 4804, removable storage 4809, and non-removable storage 4810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 4800. Any such computer storage media may be part of device 4800. Computing device 4800 may also have input device(s) 4812 such as a keyboard, a mouse, a pen, a sound input device, a touch input device, etc. Output device(s) 4814 such as a display, speakers, a printer, etc. may also be included. The aforementioned devices are examples and others may be used.

Computing device 4800 may also contain a communication connection 4816 that may allow device 4800 to communicate with other computing devices 4818, such as over a network in a distributed computing environment, for example, an intranet or the Internet. Communication connection 4816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 4804, including operating system 4805. While executing on processing unit 4802, programming modules 4806 (e.g., application 4820) may perform processes including, for example, one or more stages of methods 300-900, algorithms, systems, applications, servers, databases as described above. The aforementioned process is an example, and processing unit 4802 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

What is claimed is:

1. A method of facilitating training based on media, the method comprising:
receiving, using a communication device, a trainer media from a trainer device;
storing, using a storage device, the trainer media;
transmitting, using the communication device, the trainer media to a trainee device;
receiving, using the communication device, a trainee media from the trainee device;
storing, using the storage device, the trainee media;
analyzing, using a processing device, the trainee media;
generating, using the processing device, at least one trainee characteristic based on the analyzing of the trainee media;
transmitting, using the communication device, the at least one trainee characteristic to the trainee device.

2. The method of claim 1 further comprising:
receiving, using the communication device, a trainer script from the trainer device;
associating, using the processing device, the trainer script with the trainer media; and
storing, using the storage device, the trainer script.

3. The method of claim 1 further comprising:
transmitting, using the communication device, the trainee media to at least one coach device;
receiving, using the communication device, coach feedback from the at least one coach device;
storing, using the storage device, the coach feedback in association with the trainee media;

4. The method of claim 1 further comprising:
analyzing, using the processing device, the trainer media;
generating, using the processing device, at least one trainer characteristic based on the analyzing; and
transmitting, using the communication device, the at least one trainer characteristic to the trainee device.

5. The method of claim 1 further comprising:
generating, using the processing device, trainee text corresponding to trainee speech comprised in the trainee media based on the analyzing of the trainee media;
storing, using the storage device, the trainee text in association with the trainee media;
transmitting, using the communication device, the trainee text to the trainee device.

6. The method of claim 1, wherein the at least one trainee characteristic comprises at least one emotional indicator, wherein the analyzing comprises:
identifying, using the processing device, a face of the trainee; and
recognizing, using the processing device, the at least one emotional indicator associated with the face.

7. The method of claim 1, wherein the trainer media comprises a prompt portion, wherein capturing of the trainee media is automatically initiated upon presentation of the prompt portion.

8. The method of claim 7, wherein the trainer media further comprises a model portion.

9. The method of claim 8, wherein at least one of the prompt portion and the model portion is associated with an interactive cue-point, wherein the interactive cue-point is configured to present at least one of the prompt portion and the model portion based on a user interaction with the interactive cue-point.

10. The method of claim 1 further comprising:
receiving, using the communication device, motion sensor data from the trainee device; and
analyzing, using the processing device, the motion sensor data, wherein generating the at least one trainee characteristic is further based on the analyzing of the motion sensor data.

11. A system for facilitating training based on media, the system comprising:
a communication device configured for:
receiving a trainer media from a trainer device;
transmitting the trainer media to a trainee device;
receiving a trainee media from the trainee device;
transmitting at least one trainee characteristic to the trainee device;
a processing device configured for:
analyzing the trainee media;
generating the at least one trainee characteristic based on the analyzing of the trainee media; and
a storage device configured for storing each of the trainer media and the trainee media.

12. The system of claim 11, wherein the communication device is further configured for receiving a trainer script from the trainer device, wherein the processing device is further configured for associating the trainer script with the trainer media, wherein the storage device is configured for storing the trainer script.

13. The system of claim 11, wherein the communication device is further configured for:
transmitting the trainee media to at least one coach device; and
receiving coach feedback from the at least one coach device, wherein the storage device is further configured for storing the coach feedback in association with the trainee media.

14. The system of claim 11, wherein the processing device is further configured for:
analyzing the trainer media; and
generating at least one trainer characteristic based on the analyzing, wherein the communication device is further configured for transmitting the at least one trainer characteristic to the trainee device.

15. The system of claim 11, wherein the processing device is further configured for generating trainee text corresponding to trainee speech comprised in the trainee media based on the analyzing of the trainee media, wherein the storage device is further configured for storing the trainee text in association with the trainee media, wherein the communication device is further configured for transmitting the trainee text to the trainee device.

16. The system of claim 11, wherein the at least one trainee characteristic comprises at least one emotional indicator, wherein the analyzing comprises:
identifying a face of the trainee; and
recognizing the at least one emotional indicator associated with the face.

17. The system of claim 11, wherein the trainer media comprises a prompt portion, wherein capturing of the trainee media is automatically initiated upon presentation of the prompt portion.

18. The system of claim 17, wherein the trainer media further comprises a model portion.

19. The system of claim 18, wherein at least one of the prompt portion and the model portion is associated with an interactive cue-point, wherein the interactive cue-point is configured to present at least one of the prompt portion and the model portion based on a user interaction with the interactive cue-point.

20. The system of claim 11, wherein the communication device is further configured for receiving motion sensor data from the trainee device, wherein the processing device is further configured for analyzing the motion sensor data, wherein generating the at least one trainee characteristic is further based on the analyzing of the motion sensor data.
